(19) United States
(12) Patent Application Publication
(10) Pub. No.: US 2008/0231632 A1
(43) Pub. Date: Sep. 25, 2008

(54) ACCELERATED VOLUME IMAGE RENDERING PIPELINE METHOD AND APPARATUS

(75) Inventor: Peter Sulatycke, Arlington Heights, IL (US)

Correspondence Address: FITCH EVEN TABIN AND FLANNERY;VARIAN MEDICAL SYSTEMS, 120 SOUTH LASALLE STREET, SUITE 1600, CHICAGO, IL, 60603, US

(73) Assignee: Varian Medical Systems Technologies, Inc., Palo Alto, CA (US)

(21) Appl. No.: 12/053,309

(22) Filed: Mar. 21, 2008

Related U.S. Application Data
(60) Provisional application No. 60/896,022, filed on Mar. 21, 2007.
(60) Provisional application No. 60/896,030, filed on Mar. 21, 2007.

(51) Int. Cl. G06T 17/00

(52) U.S. Cl. 345/424; 345/419

(57) ABSTRACT

A multi-dimensional volume data set is rendered into a resulting image by acquiring image data and filtering the image data to provide filtered image data comprising substantially only image data contributing to the resulting image prior to applying at least one of a group including an interpolation calculation, a classification calculation, an illumination calculation, and a gradient calculation. Such a process can be performed by having a filter circuit operatively coupled to an image data memory buffer circuit to filter image data received from the image data memory buffer circuit to provide substantially only samples that contribute to the resulting image. Portions of the image rendering process including a classification calculation, an interpolation calculation, and filtering of the image data may be performed in least in part, in parallel.

### RELATED APPLICATIONS

This application claims the benefit of U.S. Provisional Application No. 60/896,022, filed Mar. 21, 2007, U.S. Provisional Application No. 60/896,030, filed Mar. 21, 2007, the contents of each of which are fully incorporated herein by this reference.

### STATEMENT REGARDING FEDERALLY SPONSORED RESEARCH OR DEVELOPMENT

This invention was made with government support under Grant No. 2R44RR019787-02 awarded by NIH. The Government has certain rights in the invention.

### TECHNICAL FIELD

This invention relates generally to processing data for imaging systems.

### BACKGROUND

Modern scientific applications generate very large three-dimensional data sets, also commonly referred to as volume data. Volume data either is generated from imaging systems that sample a three-dimensional (3D) object or produced through computer simulations. Each of these sources produces a three-dimensional grid of sample values that represent the properties inside a three-dimensional real or simulated object. The size of this data (from tens of Megabytes to Gigabytes) requires it to be visualized with computers to be fully understood. The volume data is “reconstructed” through the use of computer graphic techniques to produce images that represent various structures within the object. This ability to model interior structures provides an extremely valuable diagnostic and exploratory capability in a variety of fields. The main stumbling blocks to providing meaningful visualizations of volume data is the enormous amount of computations and bandwidth that are required. As a result, numerous acceleration techniques have been proposed to accelerate the visualization of volume data.

Volume Data Sources

One of the better known fields where three-dimensional sampling systems are employed is in the medical imaging field. A variety of three-dimensional sampling systems are used in this field, including: computer axial tomography (CAT), nuclear magnetic resonance (NMR), ultrasound scanning, positron emission tomography (PET), emission computer tomography (ECT), multimodality imaging (MMI), and X-ray scanning. All of these techniques produce a regular three-dimensional grid of sample values that represent the properties inside a three-dimensional object. In medical imaging, the three-dimensional object is typically a human body or part of it. Examples of the physical properties measured at regular three-dimensional positions include the coefficient of X-ray absorption in the CAT case or the spin-spin or the spin-lattice relaxation parameters in the case of NMR imaging. In all these cases, the measured values reflect variations in the composition, density, or structural characteristics of the underlying physical objects, thus providing knowledge about internal structures that can be used for diagnostic and exploratory purposes. This capability is invaluable in today's modern medicine.

Another example of a field that commonly uses modern sampling to produce large volume data is in the oil industry. The oil industry commonly uses three-dimensional acoustic sampling to attain information about geologic structures within the earth. Just as in medical imaging systems, the resulting volume data is used to visualize interior structures. This information helps scientists to locate new oil sources more quickly and cheaply. In addition, volume data collected over time aids scientists in maintaining current oil reservoirs, prolonging the life of a reservoir, and thus saving money.

Another method for producing volume data is through computer synthesis/generation techniques. One way to synthesize volume data is through the use of finite element computations. Example applications include: fluid dynamics, climate modeling, airfoil analysis, mechanical stress analysis, and electromagnetic analysis just to name a few. The volume data may be produced on various types of three-dimensional grids, including rectilinear, curvilinear, and unstructured grids, for example. These applications typically produce a plurality of data values at each grid point thereby producing huge amounts of volume data that must be visualized to be understood. These data values represent separate physical properties of the object being investigated. Example properties include: density, velocity, acceleration, temperature, and pressure just to name a few. Because each calculated property is present at every grid point, each property data set can be considered a separate volume data set.

Each sampled or synthesized data value is associated with a specific array index position in a grid within the volume under study. The set of adjacent data values that form polyhedra within the volume data set form what is known in the art as voxels. For example, when the grid is in the shape of equidistant parallel planes, eight neighboring data values form voxels in the shape of cubes. In other types of grids, neighboring data values may form voxels with different polyhedron shapes. For example, curvilinear grids used in computational fluid dynamics are often broken down into finer grids made up of voxels in the shape of tetrahedron. Graphic modeling and display is then performed on the tetrahedron shaped voxels. Regardless of which voxel type is being used, voxels are the fundamental structure used in the rendering of volume data because they provide the finest level of detail.

Types of Volume Rendering Systems

It is known how to utilize the above types of volume data to generate visual images of the volume data's interior structures on a display system. Volume rendering systems typically fall into two general categories: surface rendering and direct volume rendering. Either type of system can be used to display two-dimensional (2D) images of 3D volume interior structures.

In the art, direct rendering systems were developed as an alternative to surface rendering's reliance on graphics accelerators. These systems are so named because they do not produce any intermediate surface representation but instead directly produce a fully rendered raster image as output. This direct control over the complete rendering process gives direct rendering systems the distinct advantage of producing more accurate images if desired. This is accomplished by modeling continuous surfaces within the volume instead of one discrete surface. By adding together, in different proportions, discrete surfaces produced over a range of property values, a more accurate composite image can be produced. On the down side, direct rendering systems must recalculate and re-render the complete surface for images from different viewpoints. This fact, in combination with no direct hardware support, can make direct rendering a very slow process. Thus, there has been a strong need for techniques to accelerate volume rendering.

Types of Direct Volume Rendering Systems

Volume rendering algorithms are usually classified according to how they traverse the volume to be processed in the image plane. The three main classes of volume rendering systems are image-order, object-order, and hybrid. Image-order algorithms loop over each of the pixels in the image plane while object-order algorithms loop over the volume. Hybrid techniques consist of some combination of image-order and object-order techniques.

A prime example of image-order volume rendering is the raycasting algorithm. For each pixel in the viewplane, raycasting sends a ray from the pixel into the volume. The ray is resampled at equidistant sample locations and each sample is assigned an opacity and a color through a classification process. Gradients and shading of the samples are then calculated. Lastly, the colors of each sample are composited together to form the color of the pixel value. The opacity values act as weights so that some samples are more represented in the final pixel value than other samples. In fact, most samples do not contribute any color to the final pixel value.

The most often cited object-order volume rendering is splatting. Every voxel within the volume is visited and assigned a color and an opacity based on the classification process. The classified voxel is then projected onto the viewplane with a Gaussian shape. The projection typically covers many pixels. For each covered pixel the color and opacity contribution from the voxel is calculated. Pixels closer to the center of the Gaussian projection will have higher contributions. The color and opacity contributions are then composited into the accumulated color and opacity at each covered pixel. The projections can be thought of as snowballs or paint balls that have been splatted onto a wall.

One known hybrid volume rendering technique is the shear-warp technique. This technique has characteristics of both image-order and object-order algorithms. As in object-order algorithms, the data within the volume is traversed. Instead of projecting the voxels onto on the viewplane, however, samples are calculated within each group of four voxels in a slice and assigned to a predetermined pixel. Opacity and color assignments are performed as in ray tracing. Shear-warp has advantages of object-order algorithms (in-order data access) and image-order algorithms (early ray termination).

Software-based Volume Rendering Acceleration Techniques

Numerous software-based techniques have been developed to accelerate direct volume rendering. The dominant volume rendering characteristic utilized by acceleration algorithms is that only a small fraction (1-10%) of the volume actually contributes to the final rendered image. This is due to three volume rendering traits: 1) some of the volume is empty, 2) many of the samples will have a derived opacity value of zero or very close to zero and 3) samples with valid opacities may be blocked by other valid samples in front of them. The last trait prevents the blocked samples from fully contributing to the final rendered images, effectively causing the samples to have a zero or very small opacity for the particular image being rendered. The goal of these acceleration algorithms is to quickly find the samples that are not empty, have an opacity above a predetermined value (typically zero), and will contribute to the final image in a meaningful way. The samples are derived by an interpolation process from the voxels that surround the sample. Typically tri-linear interpolation is used to calculate the samples from the eight surrounding voxels in a typical square arrangement of data points. In the art, the surrounding voxels that are used to calculate the samples with good opacity values are typically called the “voxels of interest”. Only the voxels of interest actually need to be processed to create the output rendered image. Finding the voxels of interest is complicated because the voxels of interest change when the classification function or viewpoint changes.

A common technique used to eliminate the samples blocked by other samples, described as trait three above, is call early ray termination. This technique is usually used in conjunction with front-to-back raycasting algorithms and works by terminating the casting of a ray once the accumulated opacity exceeds a predetermined value (for example, 0.97). Once a ray has an opacity that is very close to 1.0, there is no point in processing the remaining voxels that would be intersected by a ray because the derived samples will contribute so little to the output image. For example, if 0.97 is used as the predetermined early ray termination value, at most all of the voxels intersected by the ray after the early ray termination point will only contribute 3% to the output rendered image. This amount insignificantly changes the output image and thus is not worth the extra processing.

Software-based acceleration methods have also been developed to take advantage of the first two traits described above. Software-based image-order systems (for example, raycasting) running on standard central processing units (CPUs) are accelerated by not fully processing the samples that turn out to have an opacity below a predetermined value (typically zero). For samples with an opacity below the predetermined value, this simple comparison can avoid the calculations that go after classification, such as gradients, shading, and compositing. Only interpolation and classification processing need to be done for these samples. For a given classification function, some volume rendering systems have incorporated acceleration techniques that also eliminate the interpolation and classification processing. In the art, these acceleration techniques are commonly referred to as “space leaping”. The space leaping algorithms preprocess the volume data set for a given classification function and determine all of the voxels of interest. This information is then stored in some type of data structure that is then used to quickly skip or leap over the voxels that are not of interest. This technique has the following disadvantages: 1) all of the preprocessing must be repeated when the classification function changes, 2) the data structures require a significant amount of storage and 3) the data structures usually do not skip all unnecessary data.

Hardware-based Volume Rendering Acceleration Techniques

Some of the above described software techniques have been adapted to run in a limited fashion on hardware-based volume rendering systems. A very coarse grain “space leaping” technique was developed that avoided the loading of some unnecessary voxel data from memory (for example, RAM) into the volume rendering system. The voxel data would have produced samples that had an opacity below a predetermined minimum and thus did not need to be loaded in the hardware volume renderer. In addition, volume rendering systems have also avoided the loading of voxel data into the hardware volume renderer if the samples were clipped or cropped. Simple comparison tests in the hardware volume renderer are used to determine if large groups of voxels, such as blocks or slices, can be clipped and cropped all at once.

These acceleration methods are all course grain and only prevent large groups of voxels from being loaded into and processed by the hardware-based volume renderer. Prior art acceleration algorithms are not designed to eliminate the processing of individual voxels or samples once they have been loaded into the hardware-based volume renderer. For example, a prior art hardware-based volume renderer handles the clipping and cropping of individual samples by setting a visibility bit to on or off. This bit is just used by the compositor to determine whether the colors produced by the sample should be composited into the output image. If the bit is zero the sample's color is not composited into the output image. This method just creates a correct image but does not speed up the processing of the data. The sample is fully processed for no reason, wasting processing power that can be used to process valid data. Thus it would be advantageous to provide a method that avoids most of the processing of individual clipped and cropped samples and voxels when the data has already been loaded into a volume rendering system.

Similarly, prior art early ray termination techniques for hardware-based volume renderers are not very efficient. Many volume rendering systems process a group of rays, called a raybeam, at the same time to improve the data access efficiency of the volume renderer. As a result, the early ray termination of rays must be repeatedly checked as all of the rays in a raybeam are repeatedly accessed in a loop. A raybeam can not terminate until all of the rays within a raybeam have terminated. To avoid fully retesting rays that have already terminated, prior art systems use a bit mask to record the early ray termination information of individual rays. This method prevents additional samples from being processed in a terminated ray. However, it takes time to check the early ray termination status bit to determine if a ray should be processed. During this wasted cycle no new valid data is sent into the volume rendering pipeline. Pipeline implementation and processing is a well known in the art. As a result of the wasted cycle, one less valid sample would have been processed by the hardware volume renderer, effectively stalling the pipeline. Note that many cycles can be wasted on already terminated rays because they are repeatedly tested as the raybeam is repeatedly looped over until all rays terminate. Similarly, data within a volume can be segmented and tagged as belonging to an object (for example, heart, lung, kidney) with a bitmask. If a predetermined bit is set to on, the sample or voxel belongs to the associated object. Prior art systems waste time processing the segmentation bitmasks of voxels and samples that are not of interest. As a result, no new valid voxels and samples are processed by the rest of the pipeline, effectively stalling the pipeline. It would be advantageous to provide a method that minimizes the wasted processing time of rays that have already early ray terminated and of segmented objects that are not of interest to the user.

Lastly, prior art hardware volume renderers do not have ability to skip the individual processing of samples that have an opacity below a minimum value (typically zero) when the data has already been loaded into the volume rendering system. Prior art systems fully process the samples in their pipelines regardless of the opacity of the sample. They are not able to do fine grain space leaping on the samples. This is unfortunate because a large percentage of data loaded into the hardware volume renderer still will not contribute to the final output image because of very low opacities. Unlike software-based volume renderers, hardware-based volume rendering systems can not accelerate the processing of invalid samples because no useful work can easily be done in place of the skipped calculations. This is due to the pipeline design used in hardware implementations. By the time it is determined that a sample is invalid and does not need to be processed the pipeline has moved forward by one cycle, effectively stalling the pipeline. Thus, it would be advantageous to provide a fine grain volume rendering acceleration method that can skip most of the processing of individual voxels and samples that have been loaded in the volume renderer and have opacities below a predetermined minimum, conserving processing resources and speeding image rendering in the process.

Previous Volume Rendering Pipelines

FIGS. 1-3 illustrate flow diagrams for three example known processes for processing data used to volume render an image from three dimensional data. Such data flow processes are commonly called pipelines because the data must flow through the various steps in a given order to be properly rendered in creating an image. In addition, each step of a pipeline can operate in parallel such that a pipeline can simultaneously process multiple data values, albeit at different processing stages. Pipelines are a common method used in the art. For example, in FIG. 1, three dimensional image data in the form of voxels stored in a memory 105 are pulled from the memory 105 via a memory interface 110. The memory interface 110 is controlled by a pipeline controller 115. The pipeline controller 115 is processing circuitry or firmware configured to control the data rendering process. As the data is pulled from the memory 105, the data is stored in an input voxels buffer 120 where the voxel data is arranged for processing in a particular order. The voxel interpolator 125 takes the voxel data from the input voxels buffer 120 to determine from the voxels each sample point that may contribute to the image, according to the method described above. For instance, interpolation weights provided by the pipeline controller 115 contribute to determining how to derive the samples from the voxel data. These samples are then temporarily stored in a samples buffer 127 where the samples are arranged for further processing in a particular order.

The samples then pass from the samples buffer 127 to a gradient calculation 130 and classification 135. The gradient calculation 130 calculates the local gradient at an individual sample. The gradient output provides an indication of the direction of the greatest change in data values centered at the sample. In effect, the gradient is equivalent to the normal of a surface that passes through the input sample. The gradient calculation 130 can consist of one of many gradient calculations, including but not limited to: central difference, intermediate difference, and Sobel gradient. These calculations are simply weighted difference calculations of the immediate samples surrounding an input sample. In addition to producing a gradient direction, gradient calculation 130 also may produce the magnitude of the gradient vector. Samples are used in the classification 135 step to determine the color (red, green, blue or RGB) and opacity (represented as alpha (a)) associated with the sample. The opacity level of the sample is used to determine the application of color for each sample as it may appear in the final image. The classification 135 step may also use the gradient magnitude to modulate the opacity value. This can be used to highlight the surfaces contained within the input volume data set. An illumination 140 step uses the calculated gradient direction to determine the illumination or lighting effect of the classified samples that will go into the final image. The illuminated, classified samples are then post filtered, composited and tested 145 for early ray termination. Post filtering determines whether the illuminated samples should be composited into the output image. For example, post filtering may consist of a depth test that would prevent the compositing of illuminated samples that exceed a predetermined depth value. Once compositing is complete, the resulting accumulated opacity is early ray terminated checked to see if it exceeds a predetermined value. If the accumulated opacity for the ray exceeds the predetermined value, additional illuminated samples from the ray will not significantly contribute to the final image. As a result, no additional processing is required for that ray, and it is early ray terminated. The early ray termination determination is fed to the pipeline controller 115 to assist in the control of further data processing. The remaining data continues to the pixel buffer 155 to facilitate display of the final resulting image.

FIG. 2 shows another known pipeline for processing three dimensional image data. In this example, the process of FIG. 2 proceeds much like FIG. 1 except that a gradient interpolator 210 interpolates gradients from the voxel data to provide gradient information. In the process of FIG. 1, the gradient information can be calculated directly from the samples. FIG. 3 shows another known pipeline where the classification 135 of the data is performed before the sample values are interpolated from the voxel data (also known as “pre-classification,” meaning classification is done before interpolating image data from the voxel data; “post-classification” refers to the opposite, where classification is done after interpolating image data or samples from the voxel data wherein FIG. 1 and FIG. 2 are examples of post-classification). In this example, an RGBA interpolator 310 interpolates the color and samples from the classified voxel data to provide information for the illumination 140 step.

In each of these prior pipelines, every portion of the three dimensional image data is processed through the whole pipeline until the post filter and early ray termination test 145. Given that only 1-10% of the image data actually contributes to the final image, a large amount of processing resources is wasted on processing the unnecessary data through the pipeline. In effect, the prior pipelines are stalling and not processing any useful data the majority of the time.

### BRIEF DESCRIPTION OF THE DRAWINGS

The above needs are at least partially met through provision of the accelerated volume image rendering pipeline method and apparatus described in the following detailed description, particularly when studied in conjunction with the drawings, wherein:

FIG. 1 comprises a flow diagram of a previous image rendering pipeline;

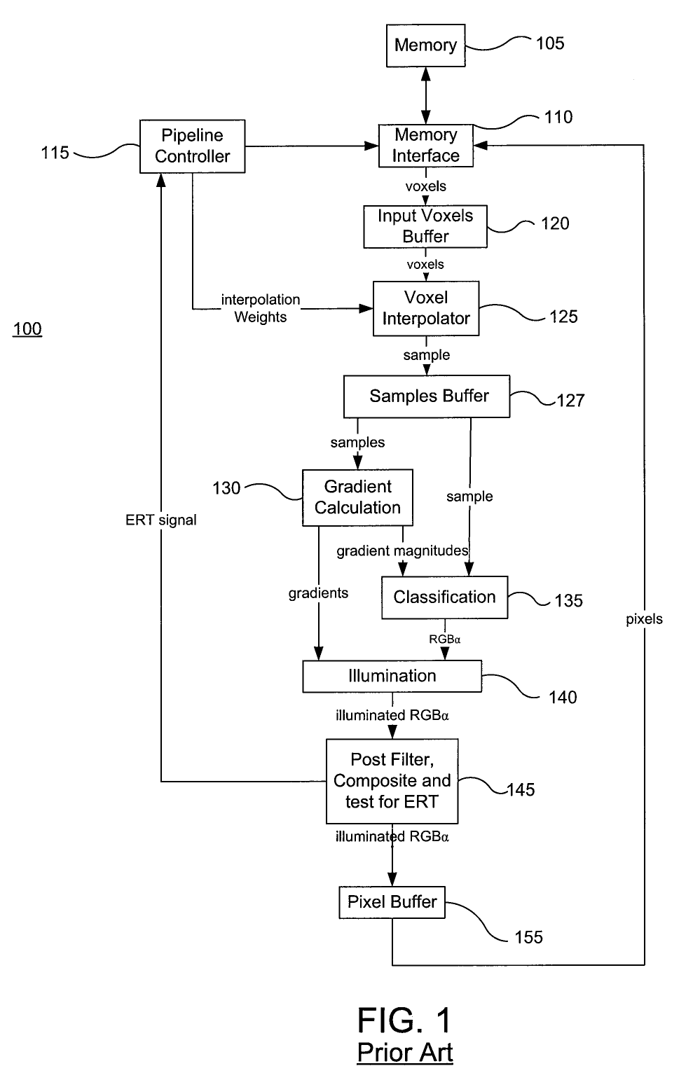

FIG. 2 comprises a flow diagram of a previous image rendering pipeline;

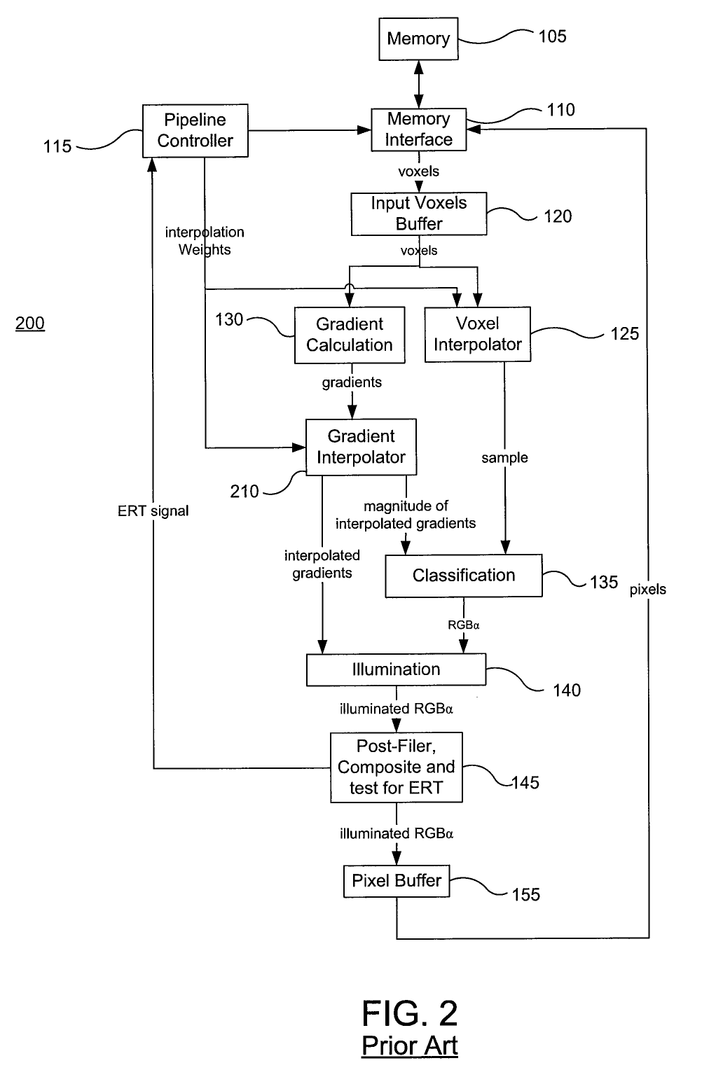

FIG. 3 comprises a flow diagram of a previous image rendering pipeline;

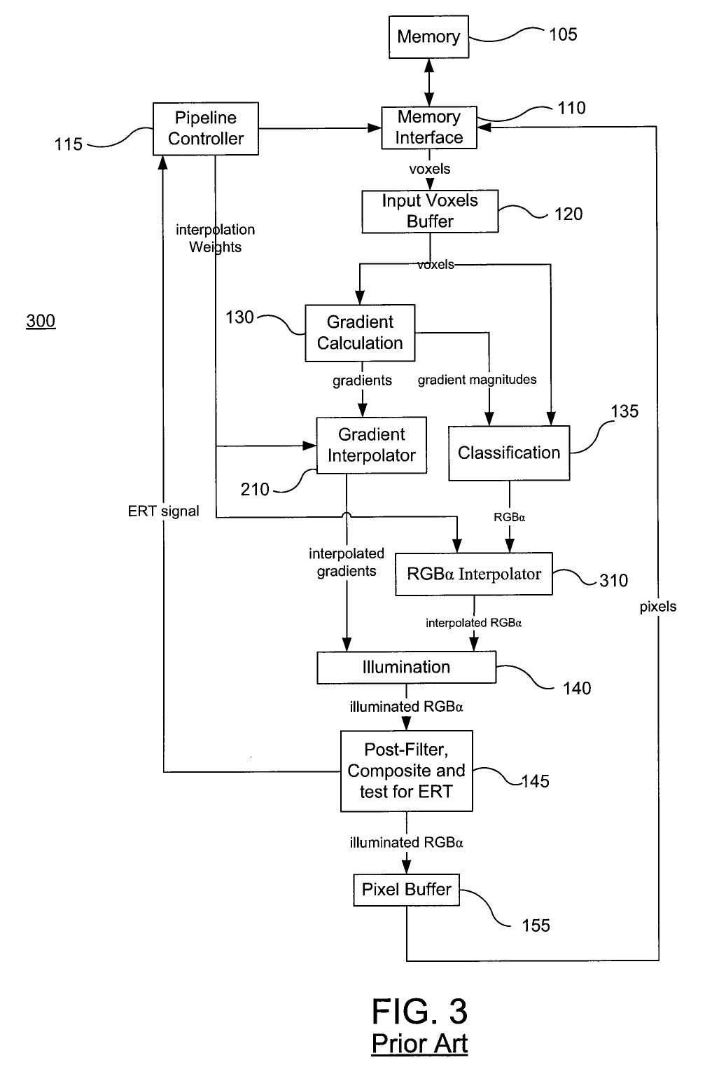

FIG. 4 comprises a flow diagram of an example image rendering pipeline with voxel filtering, post-classification, and gradients calculated from samples, in accordance with various embodiments of the invention;

FIG. 5 comprises an example voxel filtering process flow diagram;

FIGS. 6a and 6b comprise a representation of voxels in relation to a sample and gradient to be calculated from the voxels;

FIG. 7 comprises a flow diagram of an example image rendering pipeline with sample filtering, post-classification, and gradients calculated from samples, in accordance with various embodiments of the invention;

FIG. 8 comprises a flow diagram of an example image rendering pipeline with samples pre-calculated, post-classification, and gradients calculated from samples, in accordance with various embodiments of the invention;

FIG. 9 comprises an example sample filtering process flow diagram;

FIG. 10 comprises a flow diagram of an example image rendering pipeline with voxel and sample filtering, post-classification, and gradients calculated from samples, in accordance with various embodiments of the invention;

FIG. 11 comprises a flow diagram of an example image rendering pipeline with voxel filtering, post-classification, and gradients calculated from voxels, in accordance with various embodiments of the invention;

FIG. 12 comprises a flow diagram of an example image rendering pipeline with sample filtering, post-classification, and gradients calculated from voxels, in accordance with various embodiments of the invention;

FIG. 13 comprises a flow diagram of an example image rendering pipeline with voxel and sample filtering, post-classification, and gradients calculated from voxels, in accordance with various embodiments of the invention;

FIG. 14 comprises a flow diagram of an example image rendering pipeline with voxel filtering, pre-classification, and gradients calculated from voxels, in accordance with various embodiments of the invention;

FIG. 15 comprises a flow diagram of an example image rendering pipeline with sample filtering, pre-classification, and gradients calculated from voxels, in accordance with various embodiments of the invention;

FIG. 16 comprises a flow diagram of an example image rendering pipeline with voxel and sample filtering, pre-classification, and gradients calculated from voxels, in accordance with various embodiments of the invention;

FIG. 17 comprises a flow diagram of an example image rendering pipeline with sample filtering, post-classification, gradients calculated from samples, and filtering by gradient information, in accordance with various embodiments of the invention;

FIG. 18 comprises an example filtering process flow diagram using gradient information;

FIG. 19 comprises a block diagram of an example system in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENT(S)

Generally speaking, pursuant to these various embodiments, an at least three dimensional volume data set is rendered into a resulting image by acquiring image data and filtering the image data to provide filtered image data comprising substantially only image data contributing to the resulting image prior to applying at least one of a group including an interpolation calculation, a classification calculation, an illumination calculation, and a gradient calculation. Such a process can be performed by having a filter circuit operatively coupled to an image data memory buffer circuit to filter image data received from the image data memory buffer circuit to provide substantially only samples that contribute to the resulting image. Portions of the image rendering process including a classification calculation, an interpolation calculation, and filtering of the image data may be performed in least in part, in parallel.

By so processing the image data, one may determine relatively quickly whether parts of the image data are valid without fully processing the data through the entire rendering pipeline. This processing occurs at a fine level, on individual samples and voxels, and also occurs after image data has been read into the volume rendering system. By removing substantially all the data that will not contribute to the resulting image before inserting the data into the rest of the pipeline, the pipeline need not be left waiting for valid data. Instead, the pipeline will begin processing filtered data from a buffer circuit such that filtered data is available to process. So configured, the processing speed is increased because processing power is not wasted on data not used in the resulting image.

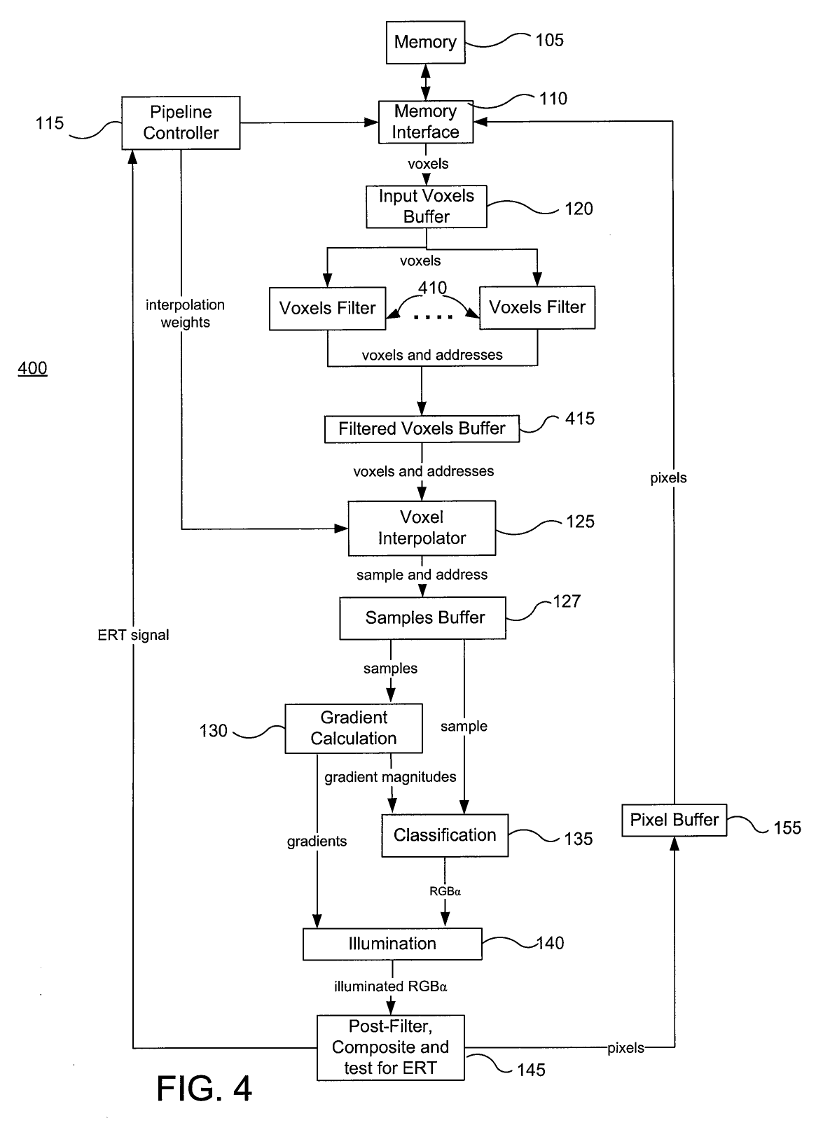

These and other benefits may become clearer upon making a thorough review and study of the following detailed description. Referring now to the drawings, and in particular to FIG. 4, an example process 400 for rendering an at least three dimensional volume data set into a resulting image will be described. Image data is acquired from a memory 105. The data stored in the memory 105 can be any source of three or more dimensional data such as medical scan data, which may be provided in near real time, visual information used in gaming, and the like. The memory 105 may be any data storage device suitable for storage and retrieval of large amounts of data. A memory interface 110 acquires the image data from the memory 105. In other approaches, the image data may be acquired at or near real-time during a scan or from another source, such as a simulation, such that the acquired data need not be re-stored in memory. The memory interface 110 is controlled by a pipeline controller 115. The pipeline controller 115 is processing circuitry or firmware configured to control the data rendering process. In this example, the image data comprises voxel data. As the image data is pulled from the memory 105, the data is stored in an input voxels buffer 120 where the voxel data is arranged for processing. The image data is then filtered by at least one, typically a plurality of, filters 410 to provide filtered image data comprising substantially only image data contributing to the resulting image. The filtered image data then is stored in a filtered voxels buffer 415 to await further processing in the pipeline when the pipeline is ready to process more data.

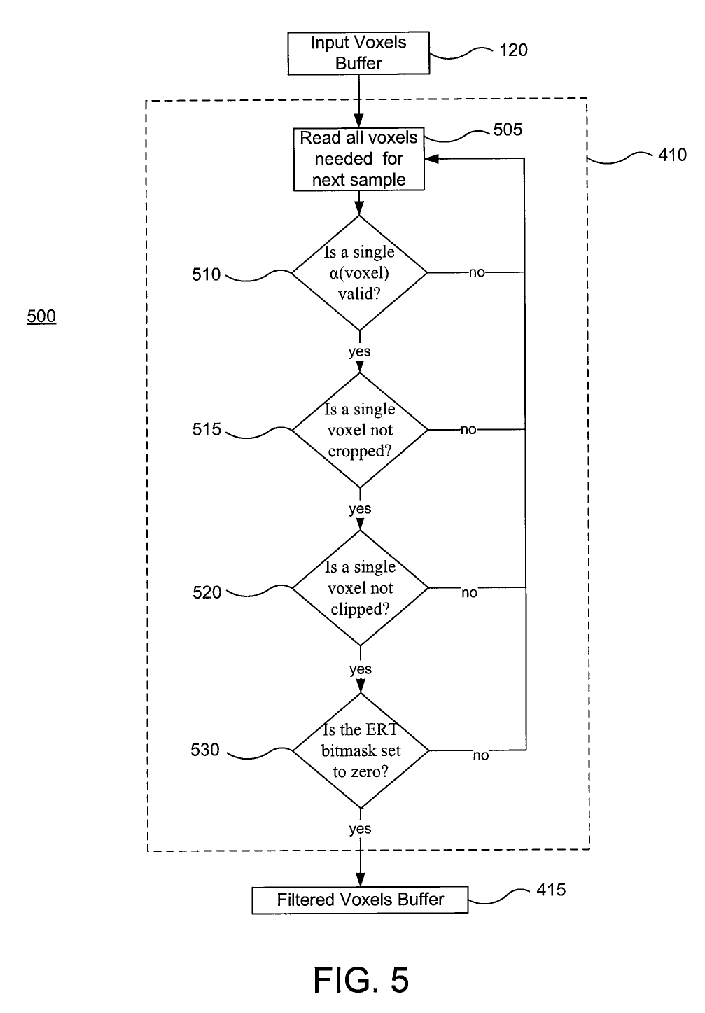

An example voxel data filtering process 500 will be described further with reference to FIG. 5. Each voxel filter 410 receives voxel data from the input voxels buffer 120 to read all the voxels for a given sample. The process 500 filters voxels to determine whether the voxels needed by the sample(s) have at least one voxel that contains data of interest. Typically, if gradients are not needed, only a cube of eight voxels is needed by the sample(s) contained within the cube. If gradients are used by the volume rendering system, which is usually the case, the number of voxels that are needed increases to more surrounding voxels because the sample may need to be used in the gradient calculation of neighboring samples even if it contains data that is not of interest. If at least one of the voxels needed by the sample(s) is valid, then it is likely that the sample(s) are also of interest and will contribute to the resulting image, or at least one of the surrounding samples will be of interest. The latter case is only important when gradients are being used by the system such that the current sample must be calculated to support adjacent gradient calculations. If any of the needed voxels are valid, processing of the sample must continue. If none of the voxels are valid, then none of the sample(s) that are dependent on the voxels can be valid and thus don't need to be processed further. The process 500 includes checking at step 510 of each of the voxel's opacity values to determine whether any of the opacity values are valid. If any one of the needed voxel's have a valid opacity then it is possible that the sample(s) will also have a valid opacity and thus contribute to the resulting image or the sample(s) may be needed by adjacent gradient calculations. If all of the voxels have an invalid opacity then the sample has an invalid opacity and will not contribute to the resulting image. This opacity checking process of each voxel can be performed using a lookup table or through a process described in U.S. patent application Ser. No. 11/864212, filed Se. 28, 2007, the contents of each of which is fully incorporated herein by this reference. By another approach, instead of checking each individual voxel's opacity, the maximum and minimum voxel values can be calculated and then a summed area table can be used to determine whether the range of voxel values contains any voxels of interest. This opacity checking process of a voxel range can also be performed through a process described in U.S. patent application Ser. No. 11/864212. The use of ranges is typically preferred because it takes less processing power. If it is determined that at least one voxel is valid, the voxels are checked to determine whether they will be cropped at step 515 and whether they will be clipped at step 520. If any one of the voxels is not cropped or clipped, then it is possible the calculated sample will also not be clipped or cropped. It is also possible that an adjacent sample that needs to have its gradient calculated will not be clipped or cropped. In either case, the sample must be processed farther. If none of the voxels have been clipped or cropped, then the derived sample(s) could not have possibly been clipped or cropped. If it is determined that the sample(s) were not clipped or cropped, an early ray termination (ERT) bitmask is checked to see if its value is zero in step 530. Zero indicates that the ray associated with the voxels has not yet terminated. Bitmasks are well known in the art, and thus need no further explanation for the sake of clarity and brevity. A raybeam bitmask stores a single bit for each ray indicating whether the ray has already terminated. If the ray has terminated, the bit is set to a value of one. If the ray has already terminated, there is no point in continuing to process samples in the associated ray. The bitmask is usually set at the completion of the compositing step 145. If any of these tests are failed, the filter process returns to read additional voxel data from the input voxel buffer 120 to check. If the voxel passes all of these tests, the voxels are passed to the filtered voxels buffer 415 for storage prior to additional processing by the pipeline. The above tests can be performed in any order, and any one or more tests may be removed from the process. Further, the voxel filter 410 may also incorporate a segmentation bitmask among other processing or filtering methods. Segmentation bitmasks indicate the objects to which a voxel belongs. The user may then indicate the objects the user would like displayed. This information can be stored in an additional bitmask that is combined with the segmentation bitmask to filter out voxels that belong to objects in which the user is not interested. Note that all of the tests in voxel filter 140 can be implemented in hardware by one skilled in the art and with minimal hardware resources.

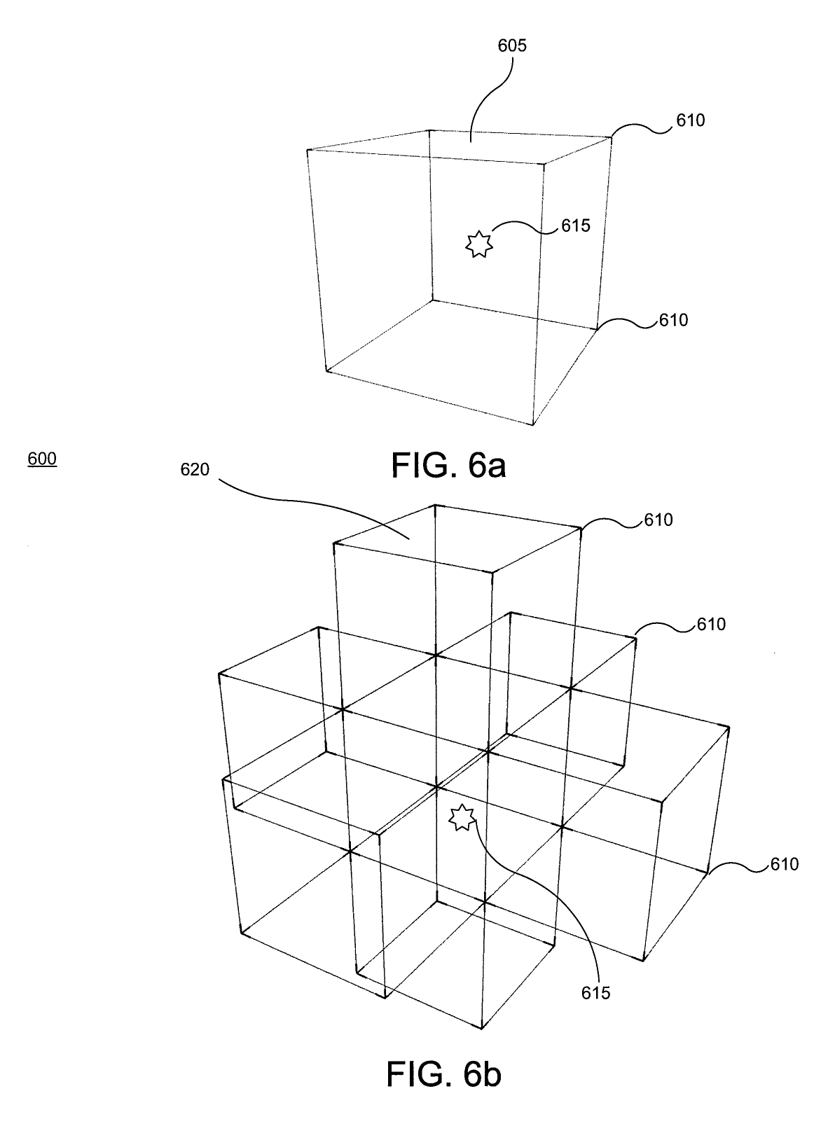

With reference to FIGS. 6a and 6b, voxel data will be further described. FIG. 6a illustrates an example group 605 of volume data arranged in a cube. The vertices of the voxel cube are the image data points 610. Depending on the image of the volume data that a user wishes to display, a point other than the voxel image data points 610 may need to be interpolated based upon the surrounding data points 610. This point, called a sample 615, is calculated from the surrounding data points based on particular algorithms known in the art, such as raycasting. For example, to determine the validity of voxel data for a sample 615 when no gradients are going to be calculated, only the eight surrounding voxel image data points 610 shown in FIG. 6a are needed when the volume image structure is a square structure. In another example, FIG. 6b shows the group 620 of voxels with voxel image data points 610 that are checked when adjacent samples need to have their gradient information calculated.

The voxels needed by a sample may also be needed by adjacent samples. Even if gradients are not calculated in a given system, each voxel may contribute to calculations for at least eight samples, leading to significant redundancy in checking the voxel values. As a result, the validity checking of voxels in a voxel filter 410 can be simplified by using a bitmask to store the validity results for subsequent validity checking. After some initialization of the bitmask, (processing of the first slice, first row of the second slice and first column of the second row in the second slice) only one new voxel will need to be checked for validity for a given sample. All other validity information can come from the bitmask.

With reference again to the example process of FIG. 4, the filtering of the voxel data occurs prior to at least one of the interpolation calculation, a classification calculation, an illumination effect calculation, and a gradient calculation. The filtered voxel data is stored in at least one filtered voxels buffer 415. By one approach, the filtered voxels buffer is a first-in-first-out buffer that stores addresses of values of a cube of eight voxels. The values of the cube of eight voxels is stored in a second buffer such that the filtered voxel data is taken from the at least one filtered voxels buffer when interpolating the voxel data. Due to hardware limitations with being able to write multiple values simultaneously to the same buffer, the number of voxels written simultaneously to filtered voxels buffer 415 may be limited. For example, there may be four voxel filters but only two voxel filters can write output to the filtered voxel buffer 415 at a time. Typically, this is not a problem because a large percentage of voxel filters will not have good data to write to the filtered voxel buffer 415. In some cases, none of the voxel filters will allow a voxel through during a processing cycle. If this happens repeatedly, the pipeline may stall, but system efficiency is not seriously affected because the amount of data removed from the system through this process increases efficiency more than efficiency may be harmed by a possible stall that may occur under this limited circumstance. If more voxel filters have good output data than are possible to be simultaneously written to the voxel buffer 415, then some of the good data will be written to the voxel buffer 415 during the next processing cycle. The above described can be used by all pipelines that process voxel image data. Voxel filters trying to write data to the voxel buffer 415 at the same time are typically ordered according to the ordering of the voxel indices. The voxel interpolator 125 interpolates the voxel data according to a ray cast through the voxel data corresponding to the resulting image to provide interpolated voxel data that places the voxel data in image space to provide samples. For instance, interpolation weights provided by the pipeline controller 115 contribute to determining how to derive the samples from the filtered voxel data. These samples are then temporarily written into a samples buffer 127 where the samples are arranged for further processing in a particular order, for example, in a regular pattern with zero written for samples that were not created such that the samples are read from the samples buffer to calculate a gradient or to be classified. Zeroes are written to make the addressing of data easier. This is a common technique in the art.

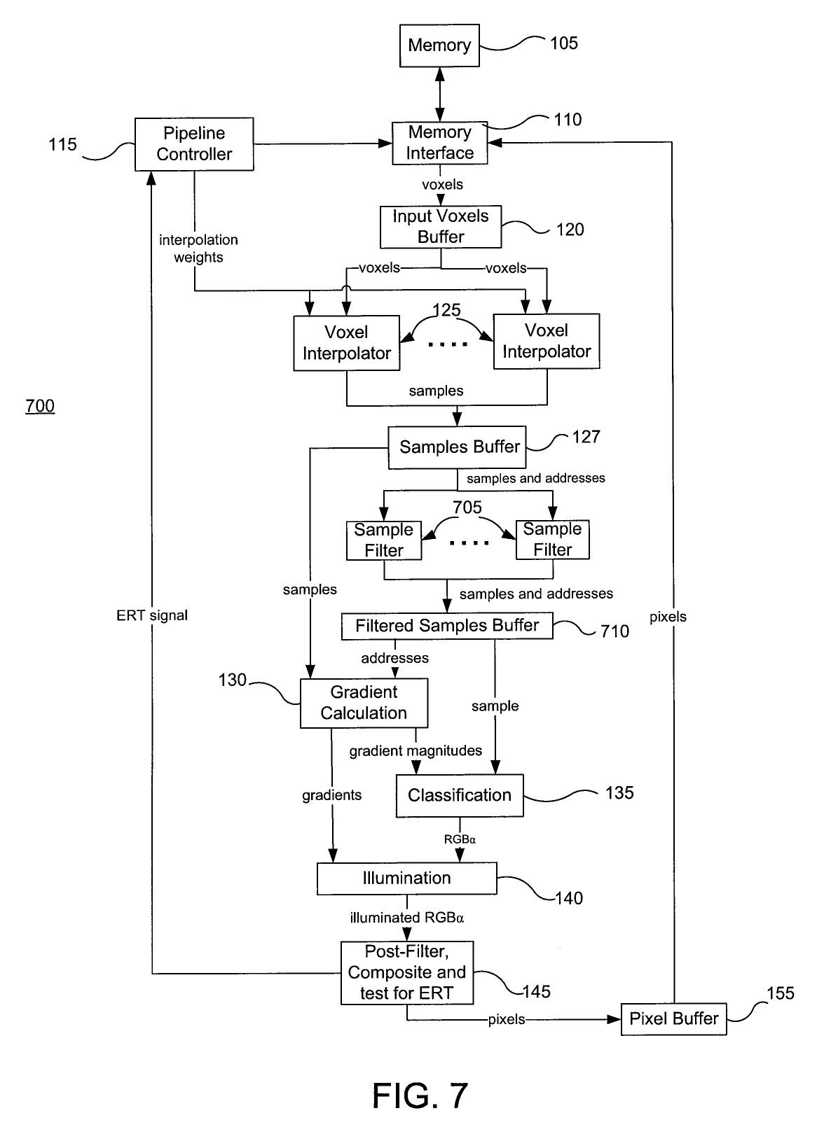

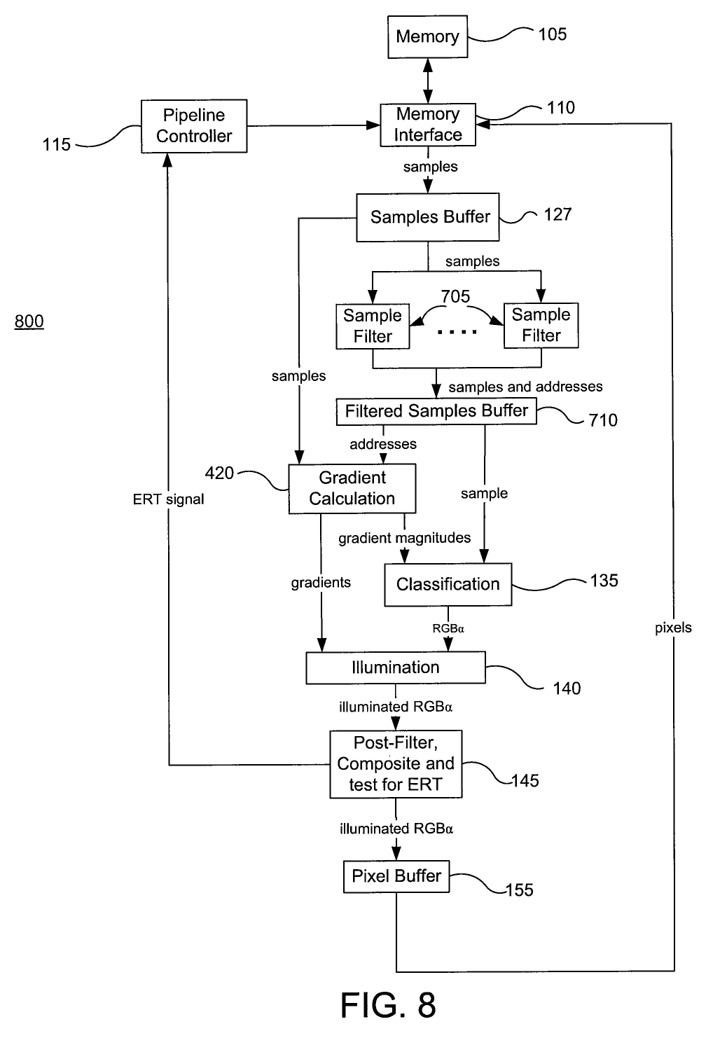

The samples then pass from the samples buffer 127 to a gradient calculation 130 and classification 135 calculation wherein the samples are classified to determine the color (red, green, blue or RGB) and opacity (represented as alpha (α)) associated with the sample. The opacity level of the sample is used to determine the application of color for each sample as it may appear in the final image. The classification 135 step may also use the gradient magnitude to modulate the opacity value. This can be used to highlight the surfaces contained within the input volume data set. The gradient values may be calculated using either the samples as shown in FIG. 4 or the voxel data as will be seen in later examples. An illumination 140 step uses the calculated gradient direction to determine the illumination or lighting effect of the classified samples that will go into the final image. The illuminated, classified samples are then post filtered, composited and tested 145 for early ray termination as described above. The remaining data continues to the pixel buffer 155 to facilitate display of the final resulting image. By another approach, with reference to FIG. 7, the image data may be filtered as samples. The pipeline process of FIG. 7 includes at least one voxel interpolator 125 to calculate samples by interpolating the voxel data from the input voxels buffer 120 according to a ray cast through the voxel data corresponding to the resulting image. By one design, a plurality of voxel interpolators 125 interpolate the voxel data in parallel to speed the interpolation process. This process provides interpolated voxel data that places the voxel data in image space or, in other words, creates samples that are written to the samples buffer 127 as discussed above. The samples are then read from the samples buffer 127 as needed to filter the samples or to apply a gradient calculation to the samples. At least one or typically a plurality of sample filters 705 filter the samples to determine whether a given sample contributes to the resulting image thereby providing filtered samples comprising substantially only samples contributing to the resulting image. The filtered samples may then be classified to provide classified samples after interpolating the voxel data to provide samples. The addresses of filtered samples may be provided to the gradient calculation 130. Typically, there are at least as many voxel interpolators 125 as there are sample filters 705 for a pipeline like the example of FIG. 7. The voxel interpolators 125 may be operated at least in part in parallel. The sample filters 705 may also be operated at least in part in parallel. Similarly, the sample filters 705 also may filter the sample data at least in part in parallel. The sample buffer 127 is not necessary if gradients are not calculated such that interpolation can feed directly into a sample filter. The filtered samples are then typically stored in a filtered samples buffer 710, although this buffer is not necessary. Another approach to the pipeline of FIG. 7 is illustrated in FIG. 8 wherein acquiring the image data from the memory 105 includes accessing stored samples in lieu of interpolating from voxel data. In other words, the samples have been pre-calculated from the voxel data and stored in memory 105 so that the samples need not be calculated as part of the pipeline process.

Due to hardware limitations with being able to write multiple values simultaneously to the same buffer, the number of samples written simultaneously to filtered samples buffer 710 may be limited. For example, there may be four sample filters but only two sample filters can write output to the filtered samples buffer 710 at a time. Typically, this is not a problem because a large percentage of sample filters will not have good data to write to the filtered samples buffer 710. In some cases, none of the sample filters will allow a sample through during a processing cycle. If this happens, the pipeline will stall, but system efficiency is not seriously affected because the amount of data removed from the system through this process increases efficiency more than efficiency may be harmed by a possible stall that may occur under this limited circumstance. If more sample filters have good output data than are possible to be simultaneously written to the filtered samples buffer 710, then some of the good data will be written to the filtered samples buffer 710 during the next processing cycle. Sample filters trying to write data to the filtered samples buffer 710 at the same time are typically ordered according to the ordering of the sample or voxel indices. The above described can be used by all pipelines that process sample image data.

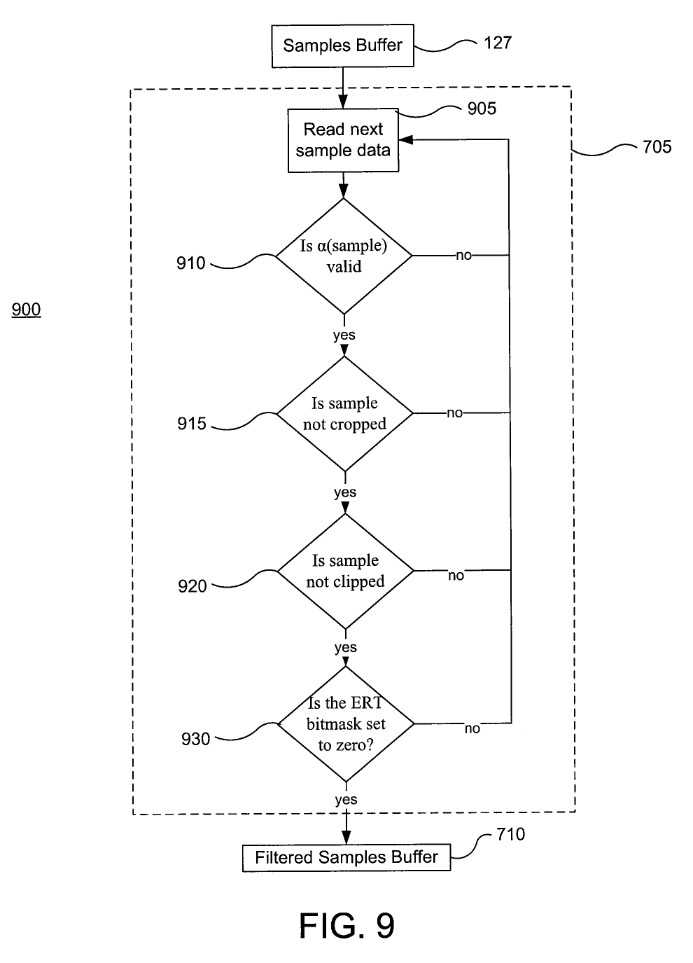

An example sample data filtering process 900 will be described further with reference to FIG. 9. Each sample filter 705 receives samples data from the samples buffer 127. The process 900 then checks whether the sample has a valid opacity at step 910 because a sample with an invalid opacity will not contribute to the resulting image. This opacity checking process can be performed using a lookup table or through a process described in U.S. patent application Ser. No. 11/864212, filed Sep. 28, 2007, the contents of each of which is fully incorporated herein by this reference. If the sample is valid, the sample is checked to determine whether it is cropped at step 915 and whether it is clipped at step 920. If it is determined that the sample is not clipped or cropped, an early ray termination (ERT) bitmask is checked to see if its value is zero in step 930. Zero indicates that the ray associated with the sample has not yet terminated. A raybeam bitmask stores a single bit for each ray indicating whether the ray has already terminated. If the ray has terminated, the bit is set to a value of one. If the ray has already terminated, continuing to process samples in the associated ray is unnecessary. The bitmask is usually set at the completion of the compositing step 145. If the sample fails any of these tests, the filter process returns to read additional samples from the samples buffer 127 to check. If the sample passes these tests, the sample is passed to the filtered samples buffer 710 for storage prior to additional processing by the pipeline. The above tests can be performed in any order, and any one or more tests may be removed from the process. Further, the sample filter 705 may also incorporate a segmentation bitmask analysis among other processing or filtering methods. Segmentation bitmasks indicate objects to which a voxel belongs. The user may then indicate which objects the user would like displayed. This information can be stored in an additional bitmask that is combined with the segmentation bitmask to filter out samples that belong to objects in which the user is not interested. Note that all of the tests in sample filter 705 can be implemented in hardware by one skilled in the art and with minimal hardware resources.

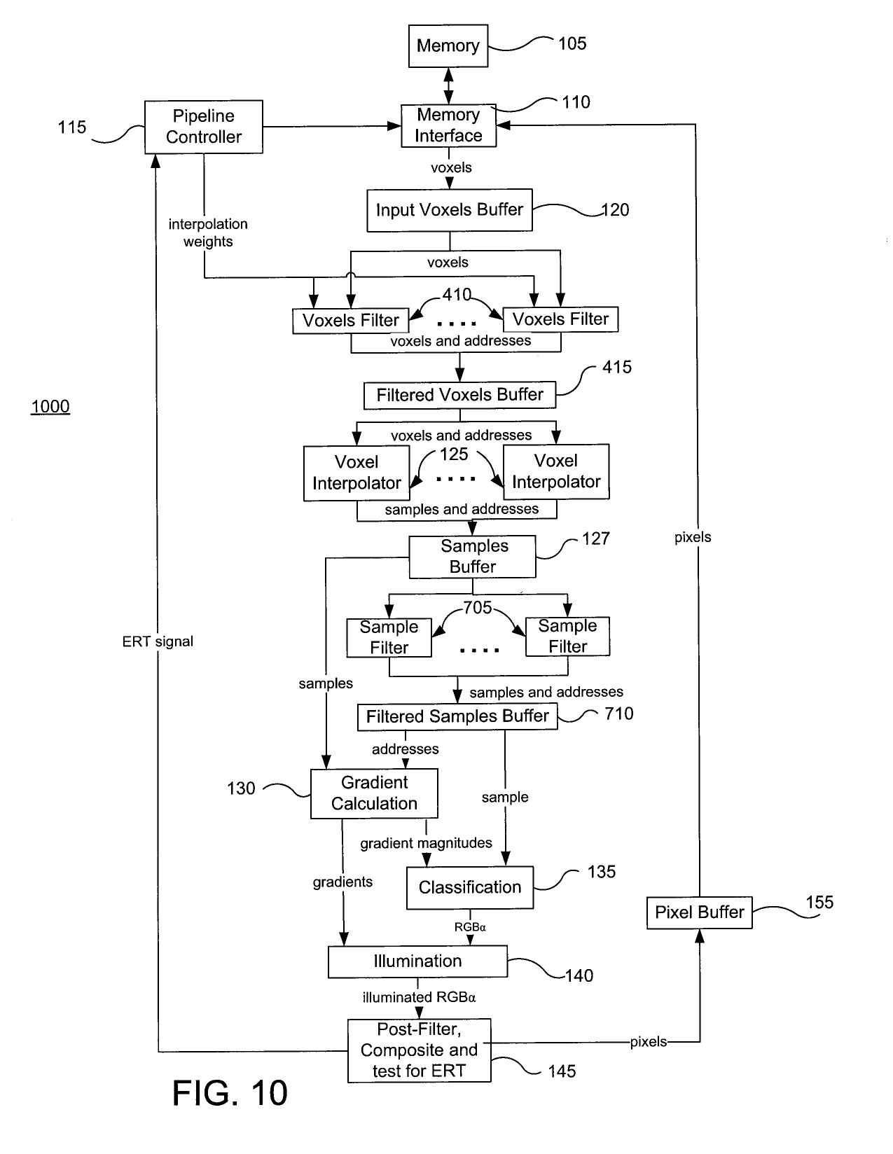

Yet another approach to the pipeline is illustrated in FIG. 10. In this example, the voxels are first filtered by the voxel filters 410 and stored in a filtered voxels buffer 415. Then, samples are calculated by interpolating the filtered voxel data via the voxel interpolators 125 according to a ray cast through the filtered voxel data corresponding to the resulting image to provide interpolated voxel data that places the voxel data in image space to obtain samples stored in the samples buffer 127. Such a pipeline typically utilizes more voxel filters 410 than voxel interpolators 125 to ensure enough data is fed to the voxel interpolators 125 to avoid stalling them. From the filtered samples buffer 127, this pipeline operates substantially similarly to that discussed in connection with FIG. 7. For instance, when calculating the gradient information, the gradient calculation 130 can obtain samples from the samples buffer 127 using sample addresses from the filtered samples buffer 710 to reduce the amount of re-writing of data during the pipeline's rendering operation.

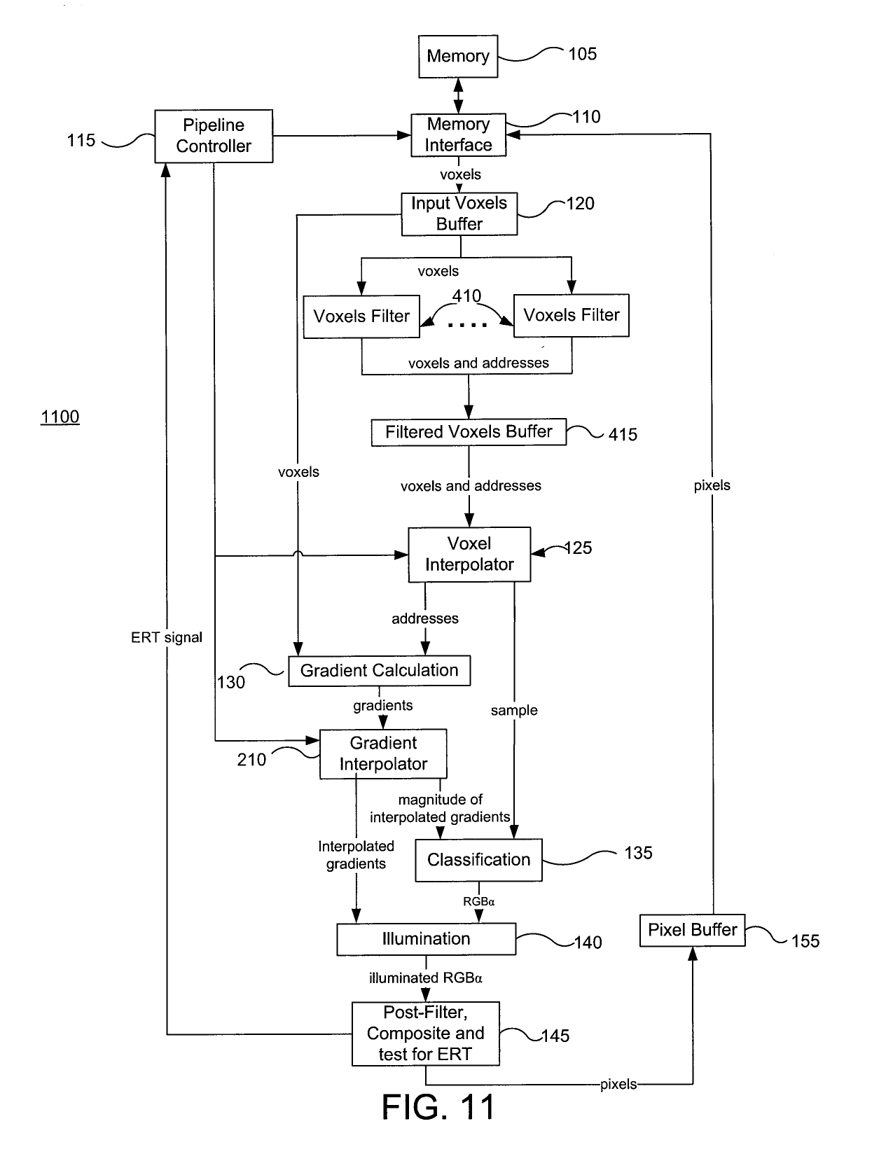

Still another approach to the pipeline will be described with reference to FIG. 11. In this example, gradient information is calculated from voxel data. Addresses of samples calculated from filtered voxel data are supplied to the gradient calculation 130 that then pulls voxel data according to the addresses to calculate gradient information that is passed to a gradient interpolated 210 step. The samples and gradient information from the gradient interpolator 210 is then processed for classification and illumination similarly to that of the other example pipelines discussed herein.

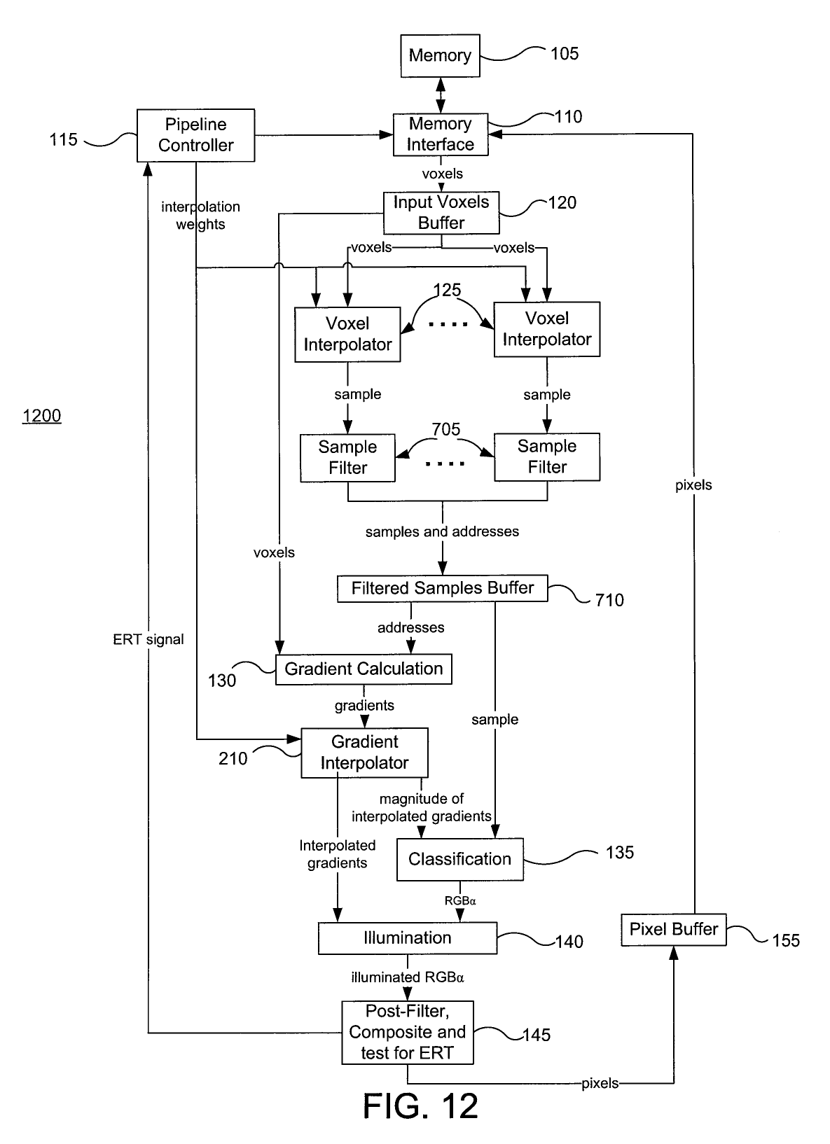

Another approach to a pipeline for rendering image data using post-classification will be described with reference to FIG. 12. In this example, voxels from the input voxels buffer 120 are interpolated by voxel interpolators 125, and the samples are filtered by sample filters 705 corresponding to the voxel interpolators 125. So configured, a samples buffer 127 is not needed because the gradient information is calculated using the voxels and addresses from the filtered samples buffer 710. One skilled in the art will recognize that a sample address can readily be converted to a voxel address during gradient calculation thereby allowing gradient information to be calculated using sample addresses and voxels. The remaining process is then similar to that of the other example pipelines discussed herein.

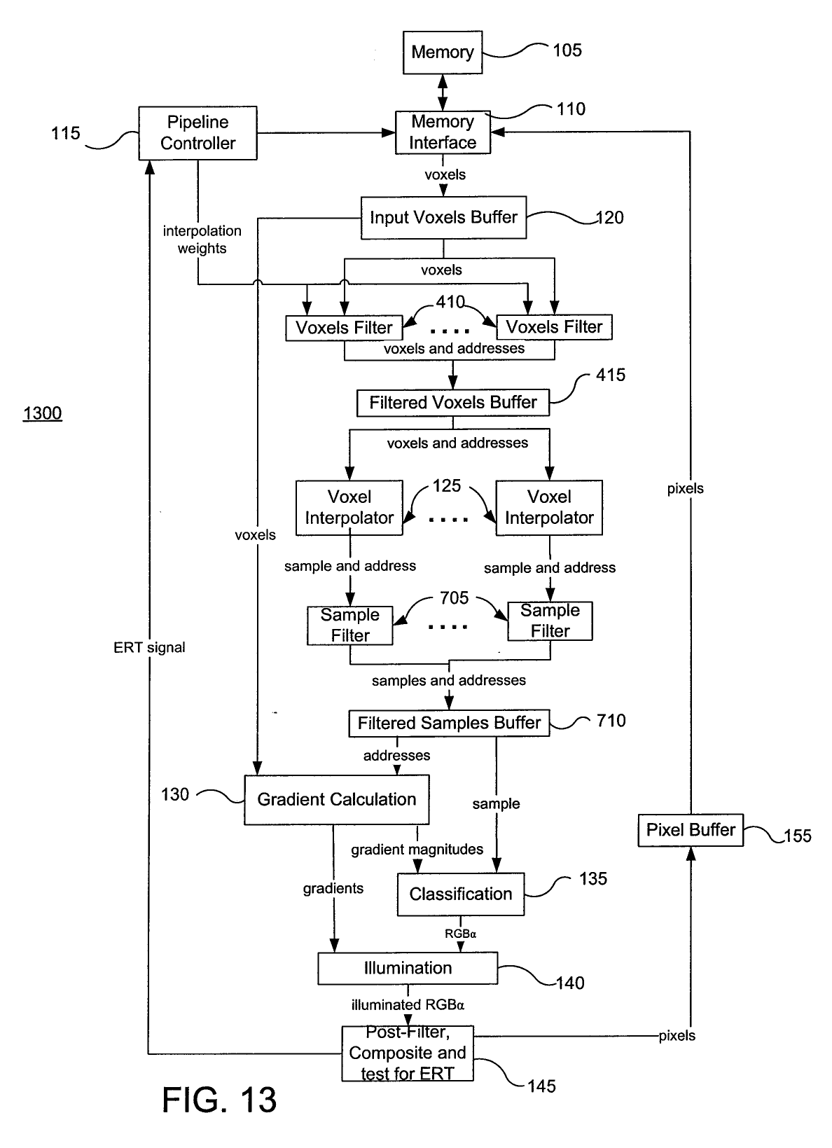

Still another approach for rendering image data will described with reference to FIG. 13. This example expands on that of FIG. 12 by filtering the voxel data using voxels filters 410 prior to voxel interpolation 125 and sample filtering 705. Like the example of FIG. 12, a samples buffer 127 is not needed because the gradient information is calculated using the voxels and addresses from the filtered samples buffer 710. If gradients are not calculated, then the sample filter is not necessary because the voxel filter will filter out nearly all of the samples that will not contribute to the resulting image. The remaining process is then similar to that of the other example pipelines discussed herein.

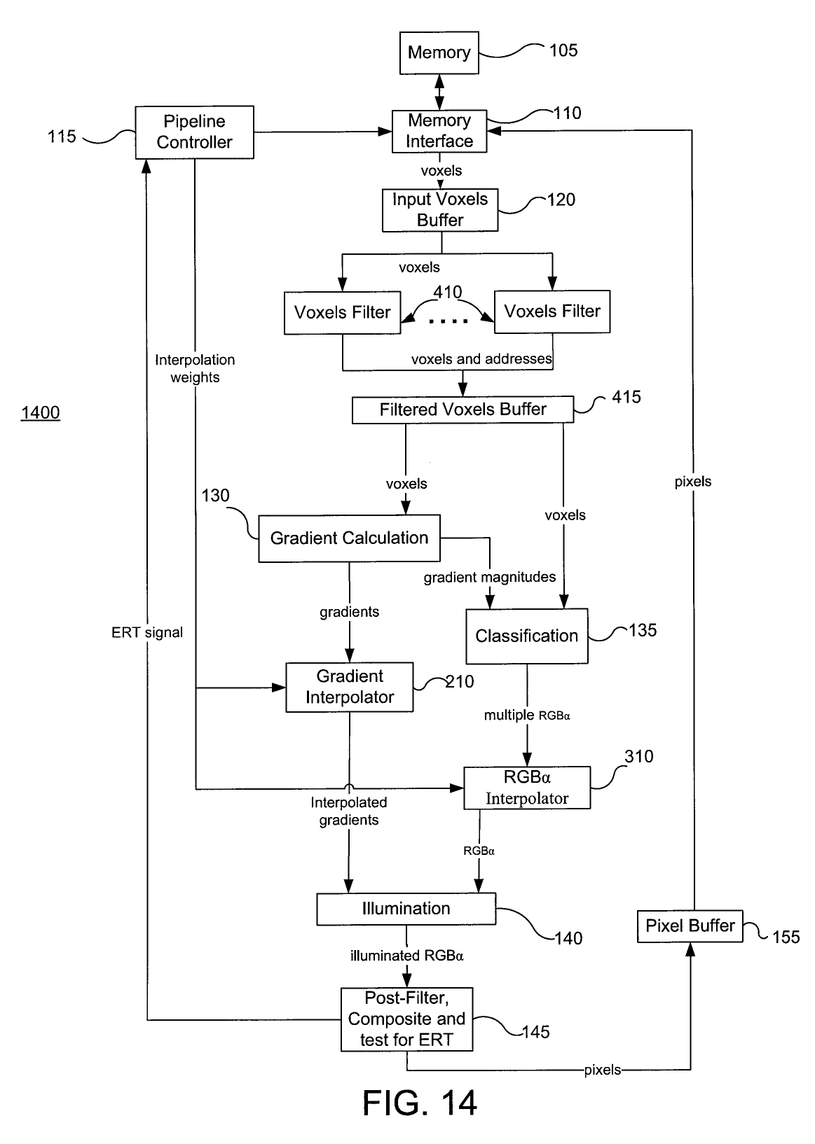

The example of FIG. 14 shows an image rendering process in accordance with these teachings using pre-classification. In this example, voxel data is filtered by the voxels filters 410, and the filtered voxel data is stored in the filtered voxels buffer 415, typically such that enough filtered voxels are ready to be processed before the rest of the pipeline begins processing. So configured, different parts of the pipeline may operate in parallel without stalling. Classification 135 and gradient calculation 130 is performed on the filtered voxel data from the filtered voxels buffer 415. In this pre-classification configuration, the classification 135 step classifies at least a portion of the filtered voxel data to provide classified voxel data before interpolating the voxel data. Then a gradient calculation can be applied to at least a portion of the filtered voxel data in parallel with classifying at least a portion of the filtered voxel data. This process includes the pipeline controller's controlling when to apply a gradient calculation to at least a portion of the filtered voxel data and when to classify at least a portion of the filtered voxel data such that these portions of the process may be done in parallel. It should be noted, however, that in this example the gradient calculation 130 for a particular set of voxels can only be done in parallel with the classification 135 step if the gradient magnitudes are not used in the classification step. (Parallel in this context refers to one or more calculations taking place at the same time on the same data. This is different from the natural parallelism found in pipelines that allow all steps to operate in parallel but on different data.) The gradient interpolator 210 interpolates the gradient information from the gradient calculation 130, and the RGBα interpolator 310 interpolates classified voxels that have had color and opacity assigned to them in the classification 135 step.

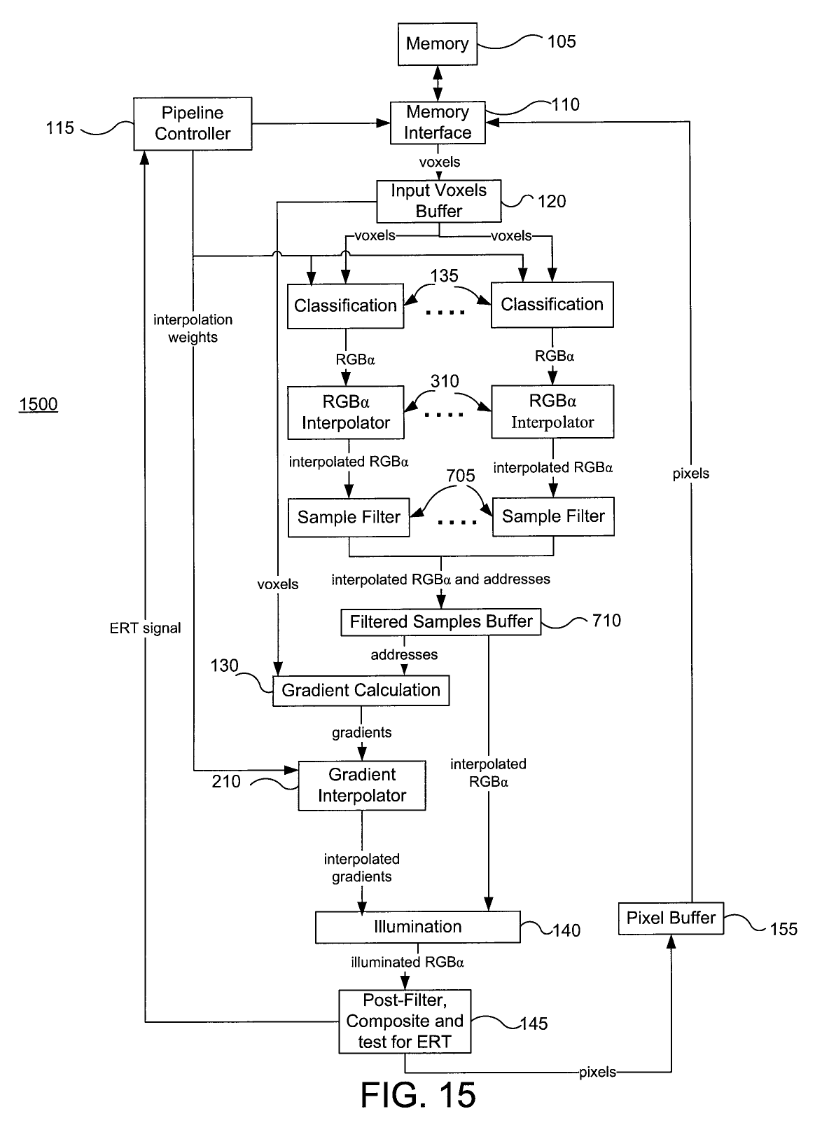

Another approach to using pre-classification will be described with reference to FIG. 15. In this example, classification 135 is performed on the voxels by one or more classification 135 steps from input voxels buffer 120 such that the voxel data is classified to provide classified voxel data before interpolating the voxel data. The classified voxel data is then interpolated by the one or more RGBA interpolators 310 prior to filtering by the sample filters 705 and storage in the filtered samples buffer 710 in advance of further processing by the pipeline. The filtered samples buffer 710 is not necessary, but its inclusion can provide improved results. Another implementation that in some cases may increase efficiency includes splitting the RGBA interpolators 310 into RGB interpolators and alpha (opacity or α) interpolators. The alpha interpolators stay in the same place in this example pipeline whereas the RGB interpolators may be moved after the sample filters 705. This can be done because the sample filters only require the alpha value and not the RGB values for the samples. By moving the RGB interpolators after the sample filter, no unnecessary RGB interpolation need be done on samples that will not pass through the sample filter 705. The classification, interpolation, and filtering steps may be linked together and then replicated many times such that results from each step pass directly to the next step leading up to the filtered samples buffer 710.

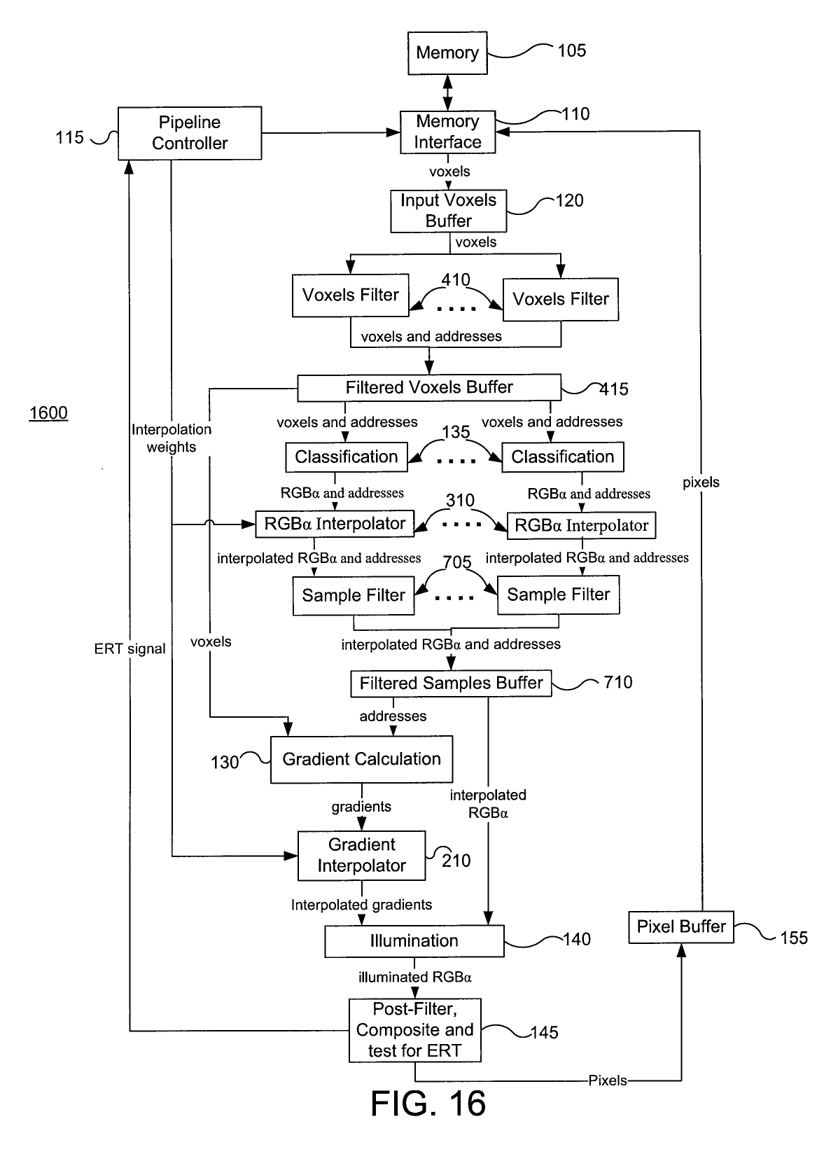

Yet another approach to rending image data using pre-classification will be described with reference to FIG. 16. In this example, the voxels are filtered by the voxels filters 410 and stored in the filtered voxels buffer 415. The filtered voxel data is then classified by one or more classification 135 pipelines to provide classified filtered voxel data such that the step of calculating samples includes calculating samples by interpolating the classified filtered voxel data. Like the example of FIG. 15, the step of classifying the filtered voxel data to provide classified filtered voxel data may be performed by a plurality of classification units 135. By one approach, at least a portion of the classified voxel data is written to the filtered voxels buffer 415 such that at least a portion of the classified voxel data is reused by at least one of the classification 135 process or application of a gradient calculation 130 to at least a portion of the voxel data. The interpolation, sample filtering, and remaining processing proceed similarly to the process of FIG. 15.

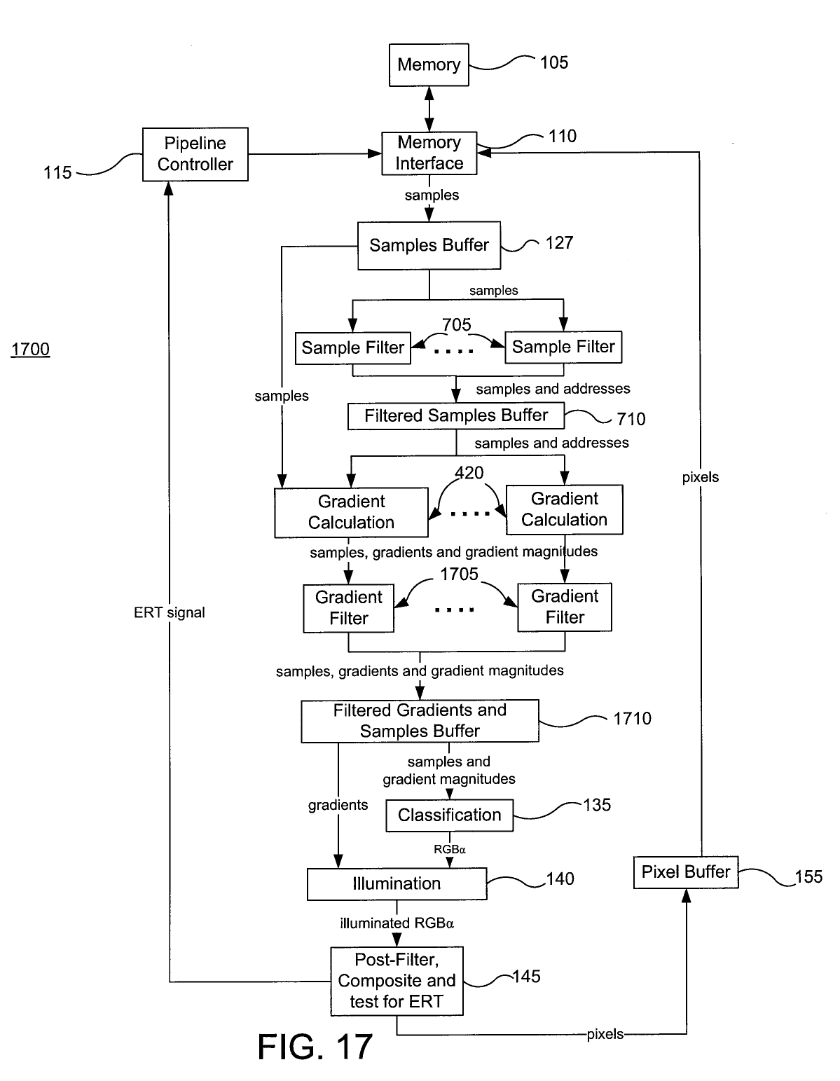

Yet another approach to the pipeline is illustrated in FIG. 17. In this example, the image data comprises samples, usually pre-calculated from voxel data, such that filtering the image data includes filtering the samples with sample filters 705 to provide filtered samples stored in the filtered samples buffer 710. A gradient calculation 420 is then performed on the filtered samples, preferably using a plurality of gradient calculation units. The data from the gradient calculation 420 is then passed to a gradient filter 1705 that filters samples based on a gradient value associated with the samples. The gradient value may be at least one of a group including a gradient magnitude, a gradient curvature value, a gradient second derivative, and a gradient direction value. The gradient filtering process then sends the filtered data to a filtered gradients and samples buffer 1710 to await further processing in accordance with other example processes described herein. It should be noted, however, that when gradient filtering is included in a processing pipeline, the classification 135 step should be moved to after the gradient filtering step. Also, more sample filters 705 are generally needed than gradient filters 1705 to ensure sufficient data is available to keep the gradient filters 1705 operating.

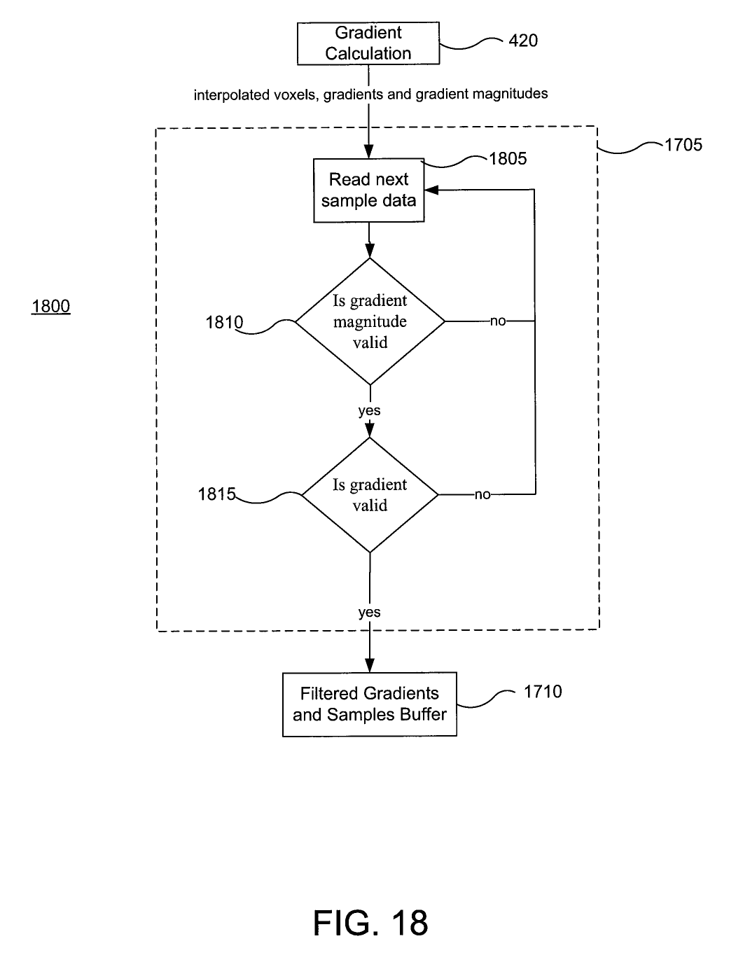

Gradient filtering will be described further with reference to FIG. 18. The gradient calculation 420 typically results in samples, gradients, and gradient magnitudes that are passed to the gradient filter 1705. The gradient filter 1705 reads 1805 the next sample data and then at step 1810 checks whether the gradient magnitude for the sample is valid, and at step 1815 the gradient filter 1705 checks whether the gradient is valid. Valid gradient magnitudes are set by the preferences of the user to highlight different objects within a volume and avoid displaying objects with very low gradient magnitude. Valid gradients may also be set by the user to highlight different objects, although this approach is less commonly used. If the gradient data for the sample fails any of these tests, the filter process returns to receive additional samples and gradient information from the gradient calculation 420. If the sample passes these tests, the sample is passed to the filtered gradients and samples buffer 1710 for storage prior to additional processing by the pipeline. The above tests can be performed in any order. Further, the gradient filter 1705 may also incorporate tests for gradient curvature, gradient second derivative, and gradient dependent features such as lighting among other processing or filtering methods. So configured, a gradient calculation can applied to the image data, which can then be filtered according to the gradient calculation to determine whether a gradient magnitude value for a given image data portion is valid, thereby providing gradient filtered image data. The gradient filtering may be applied to any of the above example pipelines for rendering image data. Note that all of the tests in gradient filter 1705 can be implemented in hardware by one skilled in the art and with minimal hardware resources.

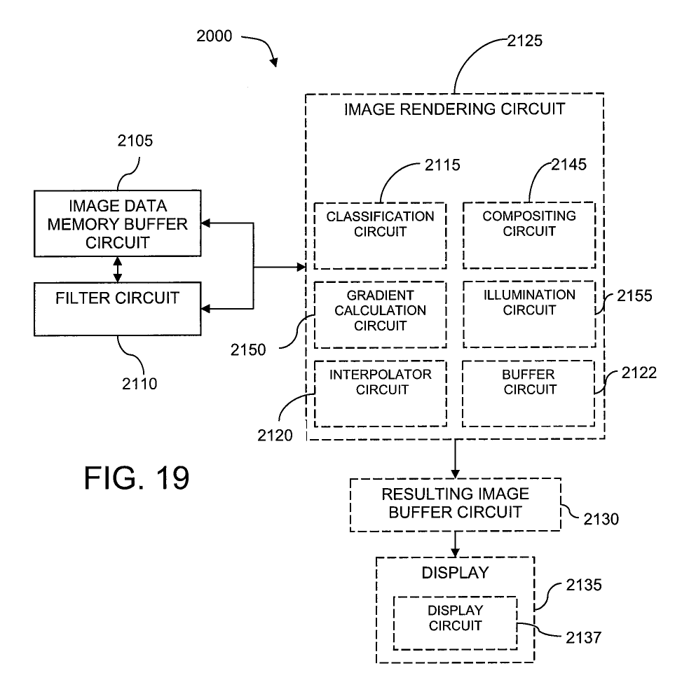

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 19, an illustrative approach to such a platform will now be provided.

A example system 2000 for rendering a three-dimensional data set into a resulting image includes an image data memory buffer circuit 2105 and a filter circuit 2110 operatively coupled to the image data memory buffer circuit 2105 to filter image data retrieved from the image data memory buffer circuit to provide substantially only samples that contribute to the resulting image. The filter circuit 2110 may include a plurality of filters operating on either voxel or sample data, depending on the application. Example filters for determining valid values are discussed above. A classification calculation circuit 2115 is operatively coupled to the filter circuit 2110 to operate upon filtered image data passing through the filter circuit 2110.

By various approaches described above, the image data is processed through an interpolator circuit 2120 operatively coupled to the image data memory buffer circuit 2105 to interpolate voxel data to provide samples as image data for the image data memory buffer circuit 2105 or directly to the filter circuit 2110 for processing. As such, the interpolator circuit 2120 may be operatively coupled to the image data memory buffer circuit 2105 and/or the filter circuit 2110. Thus, in various approaches, the image data may come directly from other sources or data acquisition devices such as a medical scanner or other data provider. For example, the image data may result from a raycasting technique, as described above, where the data may be converted from object space to image space with a rotation transformation and then be further interpolated. At least one buffer circuit 2122 may also be operatively coupled to the interpolator circuit 2120 to store interpolated data from the interpolator circuit 2120.

An image rendering circuit 2125 is operatively coupled to the filter circuit 2110 to operate upon valid image data passing from the filter circuit 2110. Optionally, a resulting image buffer circuit 2130 is operatively coupled to the image rendering circuit 2125 to receive resulting image data. A display 2135 and display circuit 2137 are operatively coupled to the resulting image buffer circuit 130 to display the resulting image. The display 2135 may be any device that can display images. The display circuit 2137 may include a typical display processing board separate from a display 2135 or may be integral with the display 2135.

The image rendering circuit 2125 may also include a compositing circuit 2145. Further, the image rendering circuit 2125 may also include a gradient calculation circuit 2150 and an illumination circuit 2155. Such portions of the system 2000 may be arranged as needed to complete the image data processing pipeline hardware for rendering the three dimensional or volume data into various displayed images. For instance, the filter circuit 2110 and the interpolator circuit 2120, as well as the other system components, are typically processor circuits such as one or more of the following examples: a field programmable gate array, an application specific integrated circuit (“ASIC”) based chip, and a digital signal processor (“DSP”) chip, each of which is known and used in the art. Other, and as of yet undeveloped circuits, may also be used as a processor circuit for various portions of the system.

Those skilled in the art will recognize and understand from these teachings that such a system 2000 may be comprised of a plurality of physically distinct elements as is suggested by the illustration shown in FIG. 19. It is also possible, however, to view this illustration as comprising a logical view, in which case one or more of these elements can be enabled and realized via a shared platform. For instance, the classification circuit 2115, compositing circuit 2145, gradient calculation circuit 2150, and illumination circuit 2155 may be separate chips or circuits, or may be combined into a single chip or circuit, such as being part of a single image rendering circuit 2125. It will also be understood that such a shared platform may comprise a wholly or at least partially programmable platform as is known in the art.

Through various applications of the teachings of this disclosure, preprocessing or prefiltering of image data volumes is not necessary. Instead the voxels or sample(s) may be processed in real-time, providing volume rendering acceleration even when the classification function changes. Pre-filtering acceleration techniques usually cannot be used to accelerate volume rendering when the classification function changes because of the excessive amount of processing and memory overhead involved. The processes taught in this disclosure do not require a significant amount of such overhead and thus may be used during any volume rendering operations, including real-time changes in the classification function.

Processing savings may be realized because classification, gradients, illumination, and compositing calculations are not usually performed prior to the filtering. Instead, filtering is accomplished by determining whether the sample value (for example, density) is valid for a given classification function by using a proprietary analysis or a lookup table. Filtering can occur even earlier in the image rendering process, on groups of voxels instead of just samples. By such an approach, the whole traditional volume rendering pipeline, including interpolation, classification, gradients, illumination and compositing, can be skipped for invalid image data removed by the filtering process. Multiple filters may be used at the same time to provide benefits to hardware-based pipelines.

The various examples provided herein may be provide certain benefits as applied in certain applications. For example, pipelines using post-classification usually produce more accurate images with fewer artifacts as compared to pre-classification pipelines. In another example, gradients calculated using samples typically provides better accuracy as compared to gradients calculated using voxels. When the viewpoint for the resulting image is not changing, there is no need to resample the volume data; in such an application, samples may be stored in memory and reused repeatedly until the viewpoint changes. The example of FIG. 8 is one such straightforward and efficient configuration that is applicable to support real-time changes in the classification function because the pipeline processes samples that have already been created and stored in memory.

When the viewpoint for the resulting is changing, for example due to user preference and setting, pipelines such as that of FIG. 10 that include both voxel and sample filters typically result in good performance without over complication of the system. If gradients do not need to be calculated, a slightly simpler pipeline such as that of FIG. 4 using only voxel filers typically provides improved performance because without gradients, fewer samples will need to be created and the voxel filters will typically be able to filter substantially all of them out thereby substantially eliminating the benefits of sample filters. For a system that must handle viewpoint changes, changes in classification, and gradient changes, a pipeline such as FIG. 10 provides good performance under all of those conditions without having an overly complicated structure.

Those skilled in the art will recognize that a wide variety of modifications, alterations, and combinations can be made with respect to the above described examples without departing from the spirit and scope of the invention. For instance, the gradient and classification calculations may be reversed in order. In many cases, the samples buffer 127 or filtered samples buffer 710 is not necessary but often provides improved operation of other processing steps such as gradient calculations that may use sample data. Gradient and illumination calculations also are not generally necessary but for improving the look of the resulting image and may be omitted from many of the examples discussed herein. Similarly, gradient information may not be necessary for the classification calculation. In such cases, classification may be incorporated into the sample filters when the sample filters calculate opacities for the samples. Any number of pipelines, including combinations of different pipelines, can be incorporated into a volume rendering system.

The number of sample filters may vary according to the application as well. Typically, the more sample filters added to the pipeline, the faster the pipeline will be able to create volume renderer image data output. Although the biggest performance gains are realized with the first additional sample filters, efficiency can be improved by adding as many sample filters as may be reasonably added to the pipeline where the limiting factor is usually how to supply the sample filters with enough data because the filters can process data with every processing cycle. The extra resources used to incorporate the filters into the system are typically worth the effort because the amount of data that needs to be processed is often significantly reduced. For example, the performance of one pipeline with four sample evaluators will approximately be equivalent to the performance of four pipelines without any sample evaluators.

The teachings of this disclosure may also be used with numerous existing volume rendering acceleration algorithms. For example, teachings of this disclosure may be applied to a shear warp algorithm and to object-based volume rendering algorithms such as splatting. This can be done without having to perform a significant amount of preprocessing every time the classification function tables change.

While the described embodiments are particularly directed to rectilinear volume data forming rectangular parallelepiped voxels, there is nothing contained herein which would limit use thereto. Any type of volume data and their associated voxels or samples, be it rectilinear, curvilinear, unstructured, or other, is amenable to processing in accordance with these teachings. As such, virtually any system capable of generating volume data may process such data in accordance with these teachings. Such modifications, alterations, and combinations are to be viewed as being within the ambit of the inventive concept.

I claim:

1. A method of rendering an at least three dimensional volume data set into a resulting image comprising:
acquiring image data;
filtering the image data to provide filtered image data comprising substantially only image data contributing to the resulting image prior to applying at least one of the group comprising an interpolation calculation, a classification calculation, a gradient calculation, an illumination effect calculation, and compositing calculation.

2. The method of claim 1 wherein the image data comprises voxel data such that filtering the image data comprises filtering the voxel data to provide filtered voxel data.

3. The method of claim 2 wherein voxel data is filtered by a plurality of filters.

4. The method of claim 2 further comprising:
storing the filtered voxel data in at least one filtered voxels buffer;
interpolating the voxel data according to a ray cast through the voxel data corresponding to the resulting image to provide interpolated voxel data that places the voxel data in image space to provide samples; and
classifying the samples to provide classified samples after interpolating the voxel data to provide samples.

5. The method of claim 4 further comprising:
calculating gradient values using at least one of the group comprising the samples and the voxel data.

6. The method of claim 2 further comprising:
classifying at least a portion of the filtered voxel data to provide classified voxel data before interpolating the voxel data.

7. The method of claim 6 further comprising applying a gradient calculation to at least a portion of the filtered voxel data in parallel with classifying at least a portion of the filtered voxel data.

8. The method of claim 7 further comprising controlling when to apply a gradient calculation to at least a portion of the filtered voxel data and when to classify at least a portion of the filtered voxel data.

9. The method of claim 2 further comprising:
calculating samples by interpolating the filtered voxel data according to a ray cast through the filtered voxel data corresponding to the resulting image to provide interpolated voxel data that places the voxel data in image space; and
filtering the samples to provide filtered samples.

10. The method of claim 9 wherein the step of filtering the samples to provide filtered samples is performed by a plurality of sample filters.

11. The method of claim 9 wherein the step of interpolating the filtered voxel data is performed, at least in part, by a plurality of interpolators in parallel.

12. The method of claim 9 further comprising:
classifying the filtered samples to provide classified samples.

13. The method of claim 12 further comprising:
calculating gradient values using at least one of the group comprising the samples and the voxel data.

14. The method of claim 9 further comprising:
classifying the filtered voxel data to provide classified filtered voxel data such that the step of calculating samples comprises calculating samples by interpolating the classified filtered voxel data.

15. The method of claim 14 wherein the step of classifying the filtered voxel data to provide classified filtered voxel data is performed by a plurality of classification units.

16. The method of claim 14 further comprising applying a gradient calculation to at least a portion of the filtered voxel data in parallel with other processing of the filtered voxel data.

17. The method of claim 1 wherein acquiring the image data further comprises calculating samples by interpolating from voxel data according to a ray cast through the voxel data corresponding to the resulting image to provide interpolated voxel data that places the voxel data in image space such that filtering the image data comprises filtering the samples to provide filtered samples comprising substantially only samples contributing to the resulting image.

18. The method of claim 17 wherein interpolating from voxel data occurs at least in part in at least one voxel interpolator and filtering the samples occurs at least in part in at least one sample filter.

19. The method of claim 18 wherein there are at least as many voxel interpolators as sample filters and the voxel interpolators operate at least in part in parallel and the sample filters operate at least in part in parallel.

20. The method of claim 17 wherein the step of interpolating the voxel data is performed, at least in part, by a plurality of voxel interpolators in parallel.

21. The method of claim 17 wherein acquiring the image data further comprises accessing stored samples in lieu of interpolating from voxel data.

22. The method of claim 17 further comprising:
classifying the samples to provide classified samples after interpolating the voxel data to provide samples.

23. The method of claim 22 further comprising:
calculating gradient values using at least one of the group comprising the samples and the voxel data.

24. The method of claim 17 further comprising:
classifying the voxel data to provide classified voxel data before interpolating the voxel data.

25. The method of claim 24 further comprising writing at least a portion of the classified voxel data to a voxels buffer such that at least a portion of the classified voxel data is reused by at least one of classifying at least a portion of the voxel data and applying a gradient calculation.

26. The method of claim 1 wherein the image data comprises samples such that filtering the image data comprises filtering the samples to provide filtered samples and filtering the image data further comprises filtering samples based on a gradient value associated with the samples.

27. The method of claim 26 wherein the gradient value comprises at least one of the group comprising: a gradient magnitude, a gradient curvature value, a gradient second derivative, and a gradient direction value.

28. The method of claim 26 wherein filtering samples based on a gradient value associated with the samples occurs at least in part in at least one gradient filter and filtering the samples occurs at least in part in at least one sample filter.

29. The method of claim 28 wherein there are at least as many sample filters as gradient filters and the gradient filters operate at least in part in parallel and the sample filters operate at least in part in parallel.

30. The method of claim 1 further comprising:
applying a gradient calculation to the image data; and
filtering the image data according to the gradient calculation to determine whether a gradient magnitude value for a given image data portion is valid thereby providing gradient filtered image data.

31. The method of claim 30 further comprising applying a classification calculation and an illumination effect calculation to the gradient filtered image data.

32. The method of claim 1 wherein the step of filtering the image data is performed using a plurality of filters.

33. The method of claim 1 wherein the step of filtering the image data further comprises filtering samples to determine whether a given sample contributes to the resulting image.

34. The method of claim 33 wherein filtering samples to determine whether a given sample contributes to the resulting image further comprises at least one of a group comprising: checking the given sample's opacity value to determine whether the opacity value is valid; checking whether the given sample will be clipped; and checking whether the given sample will be cropped.

35. The method of claim 1 wherein the step of filtering the image data further comprises filtering voxels to determine whether a given voxel contributes to the resulting image.

36. The method of claim 35 wherein filtering voxels to determine whether a given voxel contributes to the resulting image further comprises checking the given voxel's opacity value to determine whether the opacity value is valid.

37. The method of claim 35 wherein filtering voxels to determine whether a given voxel contributes to the resulting image further comprises checking whether the given voxel will be clipped.

38. The method of claim 35 wherein filtering voxels to determine whether a given voxel contributes to the resulting image further comprises checking whether the given voxel will be cropped.

39. The method of claim 1 wherein the classification calculation, interpolation calculation, and filtering of the image data occurs, at least in part, in parallel.

40. A system for rendering a three-dimensional data set into a resulting image comprising:
an image data memory buffer circuit;
a filter circuit operatively coupled to the image data memory buffer circuit to filter image data retrieved from the image data memory buffer circuit to provide substantially only samples that contribute to the resulting image; and
a classification calculation circuit operatively coupled to the filter circuit to operate upon filtered image data passing through the filter circuit.

41. The system of claim 40 further comprising:
an interpolator circuit operatively coupled to the image data memory buffer circuit to interpolate voxel data to provide samples.

42. The system of claim 41 further comprising:
at least one buffer circuit operatively coupled to the interpolator circuit to store interpolated data from the interpolator circuit.
